(19) United States
(12) Patent Application Publication
(10) Pub. No.: US 2026/0242256 A1
(43) Pub. Date: Aug. 20, 2026

(54) CAPACITIVE-FARADAIC AND PSEUDOCAPACITIVE-FARADAIC FUEL CELLS

(71) Applicant: Technion Research & Development Foundation Limited, Haifa (IL)

(72) Inventors: Youri GENDEL, Haifa (IL); Paz NATIV, Haifa (IL); Gidon AMIKAM, Haifa (IL)

(73) Assignee: Technion Research & Development Foundation Limited, Haifa (IL)

(21) Appl. No.: 19/642,731

(22) Filed: Apr. 9, 2026

Related U.S. Application Data
(63) Continuation of application No. 17/801,252, filed on Mar. 1, 2021, now abandoned.
(60) Provisional application No. 62/983,689, filed on Mar. 1, 2020.

(51) Int. Cl. C02F 1/461; C02F 1/467; C02F 1/469; H01M 4/92; H01M 4/96; H01M 8/18; H01M 12/00

(52) U.S. Cl. CPC C02F 1/46114; C02F 1/46176; C02F 1/4672; C02F 1/4676; C02F 1/4691; H01M 8/184; H01M 12/00; C02F 2001/46142; C02F 2001/46161; C02F 2201/46115; C02F 2201/4618; C02F 2201/4619; C02F 2303/16; H01M 4/92; H01M 4/96

(57) ABSTRACT

A system and a method for separation of ions from ions-containing medium is disclosed herein, that utilizes capacitive-faradaic fuel cells (CFFC) particles coated at least partially with catalysts capable of catalyzing redox reactions provided a reductant (fuel) and/or an oxidant, thereby polarizing the particles to more effectively absorb charged species (ions) from the water upon introducing, e.g., H₂ gas or O₂ gas, in the medium during the adsorption or regeneration. The same concept is utilized in a hybrid electrochemical cell for providing a system and a method for generating and converting electrochemical energy.

### RELATED APPLICATIONS

This application is a Continuation of U.S. patent application Ser. No. 17/801,252 filed on Aug. 21, 2022, which is a National Phase of PCT Patent Application No. PCT/IL2021/050227 having International filing date of Mar. 1, 2021, which claims the benefit of priority under 35 USC § 119(e) of U.S. Provisional Patent Application No. 62/983,689 filed on Mar. 1, 2020. The contents of the above applications are all incorporated by reference as if fully set forth herein in their entirety.

### FIELD AND BACKGROUND OF THE INVENTION

The present invention, in some embodiments thereof, relates to capacitive-faradaic and pseudocapacitive-faradaic fuel cells and uses thereof for water treatment and for energy conversion and storage.

Porous carbonaceous materials (e.g., activated carbons) play a special role in water and wastewater treatment processes due to their very high porosity and surface area, tunable surface chemistry, chemical and mechanical stability. Numerous water treatment processes utilize activated carbons (AC) for the removal of natural organic matter (Matilainen et al., 2006), halogenated organics (Urano et al., 1991), pharmaceuticals (Mansour et al., 2018), chlorine residuals (Meng et al., 2018) and many other types of organic compounds. Many inorganic ions can be removed by activated carbons: perchlorate (Mahmudov et al., 2010), fluoride (Habuda-Stanic et al., 2014), nitrate (Bhatnagar and Sillanpaa, 2011), arsenic (Mondal and Garg, 2017), ions of heavy metals (e.g. Ni, Cd, Pd, Zn) (Karnib et al., 2014), chlorite and chlorate (Gonce and Voudrias, 1994) and others.

To enhance the ability of carbons to remove cations or anions they can be decorated with functional surface groups. For example, treatment by hot nitric acid and sulfuric acid result in generation of carboxylic (Li et al., 2019) and sulfonic groups (Ge et., 2014) (respectively) on the carbon surface, which increase the performance of AC in removal of metal cations (Li et al., 2019; Ge et., 2014). Sulfonated and carboxylated carbons are, in fact, strong acid cation exchanger (SAC) and weak acid cation (WAC) exchanger materials, respectively. Decoration of carbon surface with ammine groups results in anion exchanging material capable of anions removal from water and wastewater (Palko et al., 2018). Regeneration of carbons used in ions separation is normally done using concentrated solutions of acids, bases and salts, and the resulting concentrated brine must be properly disposed or treated.

Another possibility to force porous carbons to adsorb anions and cations from water or wastewater is to electrically polarize them relative to the ionic aqueous solution. The applied potential is limited to certain threshold value to avoid faradaic processes of oxidation and reduction of water. Cations and anions from solution get electrosorbed in the electric double layer of the negatively and positively polarized carbon particles (respectively) which act as the so-called capacitive electrodes. This concept is realized in capacitive deionization (CDI) processes (Porada et al., 2013). Since late 1960's when the CDI concept was proposed the process was improved via incorporation of ion exchange membranes (MCDI) (Hassanvand et al., 2017), utilization of slurry electrodes (FCDI) (Jeon et al., 2013) and introduction of one or two battery electrode(s) into the process to enhance the salt adsorption capacity of the cell and to reduce the energy demand of the process (Kim et al., 2017). Moreover, selective separation of specific ions is possible using the CDI techniques via the implementation of carbons with properly designed pore size distribution and surface chemistry (Zhang et al., 2019).

Another electrochemical desalination technique relevant to the current study is the desalinating fuel cell (Atlas and Suss, 2019). In this technology two faradaic electrodes are implemented to perform spontaneous oxidation and reduction processes (e.g., hydrogen oxidation on anode and oxygen reduction on cathode) that create the internal electric field (and the current) in the electrodialysis stack. Consequently, the desalination occurs in parallel to electrical energy production (Atlas and Suss, 2019).

### SUMMARY OF THE INVENTION

Some aspects of the present disclosure are drawn to water treatment, means for ion-separation and desalination processes, and to various aspects of energy conversion and storage, and the chemical entities that are used for the processes are also referred to herein as “capacitive-faradaic fuel cells (CFFCs)”, whereas FIGS. 1A-F illustrate the principle of the process using the micro-scale CFFCs loaded with the Pt metal catalyst.

Some aspects of the present invention related to nitrate separation and reduction into nitrogen and ammoniacal nitrogen (i.e., ammonia and ammonium ions), as discussed and demonstrated in Example 2 in the Examples section that follows below.

Other aspects of the present invention relate to macro-scale capacitive-faradaic fuel cells (CFFCs) for both ions separation and conversion and storage of chemical energy into electrical energy, as discussed and demonstrated in Example 3 in the Examples section that follows below.

Other aspects of the present invention related to copper(II) ions separation and reduction into elemental copper, as discussed and demonstrated in Example 4 in the Examples section that follows below.

Other aspects of the present invention related to perchlorate ions separation and reduction into chloride ions as discussed and demonstrated in Example 5 in the Examples section that follows below.

Thus, according to an aspect of some embodiments of the present invention, there is provided a system for decreasing an amount of ions in a liquid medium, which includes:
a first chamber that includes the medium and a plurality of conductive porous particles that comprise a catalyst in conductive contact with the particles, the catalyst is capable of catalyzing an oxidation reaction upon exposure to a reductant in the medium and/or a reduction reaction upon exposure to an oxidant in the medium, and means for introducing the reductant or the oxidant into the medium in the first chamber;
optionally a filter for separating the plurality of conductive porous particles from the medium; and
optionally a second chamber for contacting the particles with a regeneration solution subsequent to the separating, the second chamber includes means for introducing a reductant or an oxidant into the regeneration solution.

In some embodiments, the reductant is selected from the group consisting of a reductant gas, a carbohydrate, a hydrocarbon, an alcohol, a carboxylic acid, a borohydride, an organic substance soluble in wastewater, a particulate solid organic substance suspended in wastewater, and a combination thereof.

In some embodiments, the reductant gas is selected from the group consisting of hydrogen, SO₂, H₂S, CO, NH₃, CH₄ and any combination thereof.

In some embodiments, the oxidant is selected from the group consisting of an oxidant gas, an active chlorine species, a chloramine, a permanganate, a dichromate, and any combination thereof.

In some embodiments, the oxidant gas is selected from the group consisting oxygen, O₃, H₂O₂, F₂, Cl₂, NO, NO₂, and any combination thereof.

In some embodiments, each of the reductant and the oxidant is individually a gas.

In some embodiments, the reductant is hydrogen and the oxidant is oxygen.

In some embodiments, the conductive porous particles comprise activated carbon.

In some embodiments, the conductive porous particles comprise a pseudocapacitive material.

In some embodiments, the pseudocapacitive material is selected from the group consisting of a transition metal oxide and a transition metal sulfide.

In some embodiments, the pseudocapacitive material is selected from the group consisting of ruthenium oxide (RuO₂), iridium oxide (IrO₂), iron oxide (Fe₃O₄), manganese oxide (MnO₂), titanium sulfide (TiS₂), and any combination thereof.

In some embodiments, the substance is non-activated carbon.

In some embodiments, at least a portion of the surface of the conductive porous particles includes a functional group, the functional group is capable of enhancing selectivity of the particles towards specific ions.

In some embodiments, the particles are characterized by an average size of 1 μm-5 mm.

In some embodiments, the catalyst is a metallic transition metal particle or nanoparticle.

In some embodiments, the catalyst is in a form of at least one metallic metal particle attached individually to a surface of at least one of the conductive porous particles.

In some embodiments, the catalyst is a non-metal in conductive contact with the conductive porous particles.

In some embodiments, the catalyst is an enzyme.

In some embodiments, the catalyst is a microorganism.

In some embodiments, the catalyst is physically attached to the conductive porous particles and/or dissolved or suspended in the medium.

In some embodiments, the dissolved or suspended catalyst is separated from the conductive porous particles by a membrane.

In some embodiments, the membrane is an ion-exchange membrane, or a porous organic membrane, or porous inorganic membrane.

In some embodiments, the plurality of conductive porous particles is loaded in and/or on a matrix, the matrix is selected from the group consisting of a woven material, a non-woven material, a mesh, a polymeric or inorganic binder, and any combination thereof.

According to another aspect of some embodiments of the present invention, there is provided a method of decreasing an amount of ions in a liquid medium, which is effected by:
providing the system for decreasing the amount of ions in a medium as provided herein,
contacting the medium with the plurality of conductive porous particles, and
introducing the reductant or the oxidant into the first chamber such that the conductive porous particles exhibit polarization upon the exposure, thereby effecting absorption of the ions in the medium into the particles.

In some embodiments, the medium is selected from the group consisting of an aqueous medium, an ionic liquid, a molten salt, an organic electrolyte, and an organic solvent that includes an organic salt.

In some embodiments, the medium is an aqueous medium.

In some embodiments, the method further includes, subsequent to the introducing the reductant or the oxidant, filtering the medium so as to separate the particles from the medium.

In some embodiments, the method further includes, subsequent to the filtering, repeating the contacting and the introducing.

In some embodiments, the method further includes, subsequent to the filtering, contacting the particles with the regeneration solution in the second chamber, and:
if a reductant was introduced to the medium, introducing an oxidant to the regeneration solution, or
if an oxidant was introduced to the medium, introducing a reductant to the regeneration solution, thereby regenerating the particles.

In some embodiments, the method further includes, subsequent to the regenerating, recontacting the medium with the particles in the first chamber.

According to another aspect of some embodiments of the present invention, there is provided a hybrid electrochemical cell that includes:
a faradaic half-cell that includes a first electrode in contact with an electrolyte, a catalyst and means for introducing a reductant or an oxidant into the faradaic half-cell;
a capacitive half-cell that includes an electrode in contact with a second electrolyte and a plurality of conductive porous particles; and
a separator separating the faradaic half-cell from the capacitive half-cell.

In some embodiments, the first electrolyte and the second electrolyte are essentially the same.

In some embodiments, each of the first electrolyte and the second electrolyte is individually selected from the group consisting of an aqueous electrolyte, an ionic liquid, a molten salt, an organic electrolyte, and an organic solvent that includes an organic salt.

In some embodiments, the reductant is selected from the group consisting of a reductant gas, a carbohydrate, a hydrocarbon, an alcohol, a carboxylic acid, a borohydride, a particulate solid organic substance in wastewater, and a combination thereof.

In some embodiments, the reductant gas is selected from the group consisting of hydrogen, SO₂, H₂S, CO, NH₃, CH₄ and any combination thereof.

In some embodiments, the oxidant is selected from the group consisting of an oxidant gas, an active chlorine species, a chloramine, a permanganate, a dichromate, and any combination thereof.

In some embodiments, the oxidant gas is selected from the group consisting oxygen, O₃, H₂O₂, F₂, Cl₂, NO, NO₂, and any combination thereof.

In some embodiments, each of the reductant and the oxidant is individually a gas.

In some embodiments, the reductant is hydrogen and the oxidant is oxygen.

In some embodiments, each of the first electrolyte and the second electrolyte is an aqueous electrolyte.

In some embodiments, the conductive porous particles that comprise activated carbon.

In some embodiments, the conductive porous particles comprise a pseudocapacitive material.

In some embodiments, the substance is non-activated carbon.

In some embodiments, the catalyst is a metallic transition metal particle or nanoparticle.

In some embodiments, the catalyst is an enzyme.

In some embodiments, the catalyst is a microorganism.

In some embodiments, the catalyst is physically attached to the electrode and/or dissolved or suspended in the first electrolyte.

In some embodiments, the separator is an ion-exchange separator, or a porous organic separator, or porous inorganic separator.

In some embodiments, the plurality of conductive porous particles is loaded in and/or on a matrix, the matrix is selected from the group consisting of a woven material, a non-woven material, a mesh, a polymeric or inorganic binder, and any combination thereof, and the matrix is in conductive contact with the electrode.

According to another aspect of some embodiments of the present invention, there is provided a method for electrochemical energy conversion and storage, which is effected by:
providing the hybrid electrochemical cell provided herein, and
introducing the reductant or the oxidant into the faradaic half-cell thereby generating electrochemical energy.

In some embodiments, the method further includes, subsequent to the introducing
if the reductant was introduced to the electrolyte, introducing the oxidant to the electrolyte, or
if the oxidant was introduced to the electrolyte, introducing the reductant to the electrolyte, thereby converting the electrochemical energy.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-F is a schematic illustration of the principle of desalination and brine production, according to some embodiments of the present invention, wherein FIGS. 1A-C are drawn to anions, and FIGS. 1D-F are drawn to cations, and wherein FIG. 1A and FIG. 1D show the spontaneous absorption of anions and cations, respectively, using the micro-scale capacitive-faradaic fuel cells, and FIG. 1C and FIG. 1F show O₂-induced and H₂-induced adsorption of anions and cations, respectively using the micro-scale capacitive-faradaic fuel cells, according to some embodiments of the present invention, and further FIG. 1B and FIG. 1E show the H₂-induced and O₂-induced desorption of anions and cations, respectively, using the same;

FIG. 2 presents a schematic illustration of a water treatment system, based on the method of water treatment according to some embodiments of the present invention, wherein O₂-induced (gas) adsorption of anions on the micro-scale capacitive-faradaic fuel cells (CFFCs) in the fixed-bed reactor;

FIG. 3 presents a schematic illustration of a water treatment system based on the method, according to some embodiments of the present invention, wherein H₂-induced (gas) desorption of anions from the micro-scale capacitive-faradaic fuel cells (CFFCs) in the fixed-bed reactor;

FIG. 4 presents a schematic illustration of batch-mode laboratory system 20, applied in experiments, showing micro-scale CFFCs 1 compacted between glass spheres 2 in column 3 equipped with porous sintered glass discs 4, allowing medium 5 to recirculate by pump 6 via tubing 7 between chamber 8, stirred with stirrer 9, and column 3, into which fuel gas or oxidant gas are supplied from gas cylinders 10 and 11 equipped with flow rate controller 10 and gas pressure regulators 13, whereas the pH of medium 5 is monitored and recorded by pH meter 14 equipped with a glass pH probe 15;

FIGS. 5A-B are scanning electrons microscopy images of micro-scale capacitive-faradaic adsorbing fuel cells comprising Lewatit AF5 mesoporous activated carbon loaded with Pt catalysts, according to some embodiments of the present invention;

FIG. 6 presents plots of perchlorate concentration and pH versus time measured in six consecutive adsorption-desorption operations performed with micro-scale capacitive-faradaic fuel cells comprising Lewatit AF5 loaded with Pt catalysts (0.1 wt. %) and powered by hydrogen and oxygen gases ([ClO₄⁻]₀=200 mg/L, whereas the volume is 300 ml, the CFFCs loading is 7.5 g/L, H₂ and O₂ flow rates are 180-220 ml/min, and the last cycle shown in FIG. 4 was performed in ground water contaminated with perchlorate ions;

FIG. 7 presents breakthrough curves of perchlorate ions obtained in spontaneous and O₂-induced adsorption of ClO₄⁻ ions by the packed-bed column of CFFCs made of Lewatit AF5 particles loaded with Pt catalysts (5% wt). Flow rate=10 mL/min, [ClO₄⁻]₀=10 mg/L; weight of CFFCs in the column=46 g;

FIGS. 8A-B present results of H₂-induced desorption of perchlorate ions from the CFFCs column, wherein FIG. 8A presents results of H₂-induced desorption of perchlorate ions from the CFFCs column after a spontaneous adsorption of perchlorate ions, and FIG. 8B presents results of H₂-induced desorption of perchlorate ions from the CFFCs column after O₂-induced adsorption, whereas every desorption cycle shown in FIG. 8A and FIG. 8B comprised three operations conducted using 200 mL batches of deionized water;

FIG. 9 presents a schematic illustration of the principle of a two-step process for nitrate ions separation and hydrogenation using CFFCs;

FIG. 10 presents the HR-SEM image of Lewatit AF5 sphere loaded with 5% Pt-1% Cu bimetallic catalyst, and distribution of Pt and Cu loading inside the carbon sphere as determined by the EDS technique;

FIG. 11 presents the results of five consecutive cycles of O₂-induced adsorption and H₂-induced desorption/hydrogenation of nitrate ions performed with CFFCs that comprised Lewatit AF5 carbon loaded with Pt catalyst (5% wt), whereas ●—denotes the nitrate concentration during O₂-induced adsorption, ▴—denotes the nitrate concentration during H₂-induced NO₃-desorption/hydrogenation, and the pH (denoted --);

FIG. 12 presents the results of five consecutive cycles of O₂-induced adsorption and H₂-induced desorption/hydrogenation of nitrate ions performed with CFFCs that comprised Lewatit AF5 carbon loaded with 5% Pt-1% Cu catalyst, whereas ●—denotes the nitrate concentration during O₂-induced adsorption, ▴—denotes the nitrate concentration during H₂-induced NO₃-desorption/hydrogenation, and the pH (denoted --) is shown only for the last adsorption-desorption cycle;

FIGS. 13A-B present the structure and principle of macro-scale capacitive-faradaic fuel cells, wherein FIG. 13A shows macro-scale CFFC with two fixed electrodes, and FIG. 13B shows macro-CFFC with one fixed and one flowing electrode that comprises the suspension of activated carbon particles in water;

FIG. 14 presents a schematic illustration of the structure of a macro-scale CFFC with fixed electrodes, according to some embodiments of the present invention;

FIG. 15 presents a schematic illustration of a macro-CFFC structure, according to some embodiments of the present invention, with one fixed and one flowing electrode, showing the experimental system and the structure of the macro-scale CFFC with Ti/Pt—IrO₂ faradaic electrode and the flowing capacitive electrode which was a dispersion (500 mL) of AC particles (5% wt, Norit SX Ultra) in NaCl, NH₄SO₄ or NaNO₃ solutions;

FIG. 16 presents the results of operation of macro-scale CFFCs in NaCl solutions aerated and hydrogenated at varied pHs, wherein the CFFC comprised capacitive electrode made of activated carbon powder, or activated carbon fleece electrodes and faradaic electrode made of Pt wire or Ti/Pt—IrO₂ fleece, and showing the open circuit electrode potentials (OCPs) (vs. Ag/AgCl, 3 M KCl reference electrode) obtained on Pt, Ti/Pt—IrO₂, AC powder, and AC fleece electrodes in NaCl solution at varied pH levels;

FIGS. 17A-B present the results of operations of the divided macro-scale CFFC with fixed capacitive electrode made of activated carbon fleece and faradaic electrode made of Ti/Pt—IrO₂ fleece, wherein the two electrodes were separated by the Nafion 117 cation-exchange membrane, and wherein FIG. 17A shows an air-induced operation followed by the H₂-induced step, and FIG. 17B shows the H₂-induced operation followed by the Air-induced step, whereas the embodiment shown in FIG. 17A-B can be exploited for conversion and storage of energy and for ions separation;

FIG. 18 presents the results of two consequent H₂-Air cycles conducted on NaCl solutions in the batch mode macro-scale CFFC that comprised two fixed electrodes. [NaCl]₀=50 mg/L, 500 mL; activated carbon load—4.47 g, showing that oxygenation and hydrogenation of NaCl solution resulted in significant pH fluctuations between about 3.26 and about 8.5 due to ORR and HOR on Pt;

FIG. 19 presents the results of two Air-H₂ cycles conducted with NaCl solutions in the macro-scale CFFC system comprising fixed Ti/Pt—IrO₂ and activated carbon flowing electrodes. [NaCl]₀=234 mg/L, 500 mL; activated carbon load—25 g;

FIG. 20 presents the results obtained during the CFFC process operated on (NH₄)₂SO₄ solution within three consecutive steps conducted with nitrogen gas, hydrogen gas and air, using a macro-scale CFFC system, according to some embodiments of the present invention, that comprised fixed Ti/Pt—IrO₂ faradaic electrode and activated carbon flowing capacitive electrode ([(NH₄)₂SO₄]₀=529 mg/L, 500 mL; activated carbon load—25 g);

FIG. 21 presents results of five H₂-Air cycles conducted in a batch-mode system with CFFCs that comprises granular activated charcoal loaded with 0.5% Pt, wherein each cycle was conducted using 1 litre of CuCl₂ solution with and initial concentration of 100 mg/l;

FIG. 22 presents results of two H₂-induced Cu²⁺ removal operations in a batch-mode system with CFFCs that comprises granular activated charcoal loaded with 2.5% Pt, whereas each cycle was conducted using 1 litre of CuCl₂ solution with and initial concentration of 600 mg/l;

FIG. 23 presents results of CFFCs process for Cu²⁺ ions separation from a mixture of Cu²⁺, Ni²⁺, Cd²⁺, Fe³⁺, Ca²⁺, Mg²⁺ and Zn²⁺ ions, wherein the initial concentration of each metal was 100 mg/l, the volume of water in each batch was 1 liter, the regeneration solution was 1 liter of HCl with pH₀=0.5, the weight of 0.5% Pt—CFFCs in the system was 7.5 grams, and wherein ▴ denote the concentration of all non-Cu metals in treated water, ● denote cumulative concentration of all non-Cu metals in regeneration solution, x denote concentration of Cu²⁺ in treated water, and ♦ denote concentration of Cu²⁺ in regeneration solution;

FIG. 24 presents the results of perchlorate ions batch-mode separation and hydrogenation, wherein the micro-scale CFFCs (7.5 g) comprised granular activate carbon loaded with 5 wt. % Pt catalyst, and the ammonium perrhenate catalyst (700 mg/L) was dissolved in the treated sodium perchlorate solution (1 Litre, [ClO₄⁻]=200 mg/l); and

FIG. 25 is a schematic illustration of a hybrid electrochemical cell, according to some embodiments of the present invention, showing hybrid cell 30, which includes capacitive half-cell 31 equipped with electrode 32 coated with a layer of conductive porous particles 33, and faradaic half-cell 34, equipped with electrode 35 having a catalyst layer 36 and means for introducing reductant/oxidant 37, and further including separator or/and solid electrolyte 38 positioned between the two cell halves, which are electrically connected by electric bridge 39.

### DESCRIPTION OF SPECIFIC EMBODIMENTS OF THE INVENTION

The present invention, in some embodiments thereof, relates to capacitive-faradaic and pseudo-capacitive faradaic fuel cells and uses thereof water treatment and for energy conversion and storage.

The principles and operation of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

### General Concept:

The present disclosure provides a system and a method for separation of ions from water and wastewater or/and conversion and storage of energy. The technique utilizes micro- and macro-scale conductive porous particles (e.g., activated carbon) loaded with bi-functional catalyst or a mixture of mono-functional catalysts capable of redox reaction for oxidizing a reductant (interchangeably referred to herein throughout as “fuel”) substance, such as hydrogen, and reducing an oxidant, such as oxygen. The process of ions removal is based on particles that act as a micro-scale adsorption bodies, and more specifically act as capacitive-faradaic fuel cells (CFFC) which require oxygen (or another oxidant) and hydrogen (or another fuel) for the adsorption of ions during the water (or a non-aqueous medium) treatment step and desorption of ions in the brine production.

In the context of embodiments of the present invention, the CFFCs are used in the form of a plurality of particles which are required to be electrically conductive and porous. The principles of the invention are not sensitive to the shape of the particles, or their size, however, it is advantageous that the CFFCs have a large surface area and the capacity to intercalate other substances. In some embodiments, the particles are characterized by an average size of 1 μm to 5 mm.

The CFFCs are therefore preferably small, porous particles made of a conductive material, and when the application requires that the CFFCs be used in the form of an object, they can be integrated into suitable matrices, such as polymers and resins, impregnate fibers that can be woven into fabrics and meshes, or form non-woven objects. CFFCs can also be used to coat suffices of objects and thereby form electrodes and other electrochemical elements for use in electrochemical cells. The CFFCs can also be used in batches to be packed into columns for flow-treatment devices. Some of these forms have been demonstrated in the Examples section that follows below.

The material from which the CFFCs particles are made of can be carbon, such as activated or non-activated carbon, as well as other carbon allotropes, including, but not limited to carbon nanotubes, graphene, carbon aerogel and foams.

In the context of embodiments of the present invention, the term “medium” refers to a liquid substance containing ions and having electrical conductivity sufficient to allow the process based on redox reactions to take place. The medium, corresponding to an electrolyte in some embodiments of the present invention, can be an aqueous medium or a non-aqueous medium, provided that the elements of the reactions can dissolve or at least be suspended therein. The medium should also be selected to be compatible with the ingredients and elements of the system; for example, if an enzyme is used for a catalyst, the medium should be suitable for allowing the enzyme to be stable and active therein throughout the process.

Non-aqueous media include, without limitation, room-temperature ionic liquids, or RTILs that consist of salts derived from 1-methylimidazole, i.e., 1-alkyl-3-methylimidazolium. Examples include 1-ethyl-3-methyl-(EMIM), 1-butyl-3-methyl-(BMIM), 1-octyl-3 methyl (OMIM), 1-decyl-3-methyl-(DMIM), 1-dodecyl-3-methyl-docecylMIM). Other imidazolium cations include 1-butyl-2,3-dimethylimidazolium (DBMIM), 1,3-di(N,N-dimethylaminoethyl)-2-methylimidazolium (DAMI), and 1-butyl-2,3-dimethylimidazolium (BMMIM). Other N-heterocyclic cations are derived from pyridine, and include 4-methyl-N-butyl-pyridinium (MBPy) and N-octylpyridinium (C8Py). Conventional quaternary ammonium cations also form RTILs, e.g. tetraethylammonium (TEA) and tetrabutylammonium (TBA).

Other examples of non-aqueous media include, without limitation, molten salts, organic electrolytes, and organic solutions of organic salts dissolved in organic solvents.

The process provided herein, according to some embodiments of the present invention, was reduced to practice using perchlorate ion removal from NaClO₄ solutions in deionized water and ground water using two types of CFFCs prepared from Lewatit AF5 microporous carbon and powdered activated charcoal loaded with Pt (0.1% to 5 wt. %) catalysts. The very first anions adsorption operation in a sequence of adsorption-desorption operations can be conducted without oxygen gas (or another oxidant) using the ability of pristine or modified carbons in CFFCs to adsorb ions. During the O₂-forced adsorption of ClO₄⁻ oxygen reduction reaction on Pt (the faradaic electrode of the CFFCs) results in electrons' depletion from the carbonaceous part (i.e., the capacitive electrode) of the micro-scale fuel cell which leads to the adsorption of anions in its electric double layer. Hydrogen oxidation reaction applied during the regeneration of ClO₄⁻-loaded CFFCs results in electrons' accumulation on the capacitive electrode and repletion of perchlorate ions into the regeneration solution.

The herein-provided methods can also be used for the separation of cations. In this case, ion absorption by CFFCs is driven by H₂ gas (or another fuel) (an initial adsorption step takes place without hydrogen gas using the innate ability of pristine or modified carbon to adsorb ions), in a sequence of adsorption-desorption operations, whereas O₂ gas (or another oxidant) is used for regeneration (desorption) of the cations from the CFFCs.

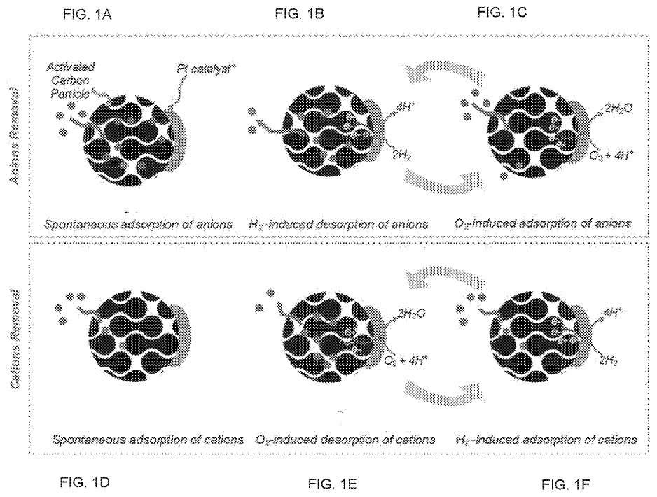

Hence, some aspects of the present disclosure are drawn to means for ion-separation and desalination processes, and the chemical entities that are used for the processes are also referred to herein as “capacitive-faradaic fuel cells” (CFFCs), whereas FIGS. 1A-F illustrate the principle of the process.

FIGS. 1A-F is a schematic illustration of the principle of desalination and brine production, according to some embodiments of the present invention, wherein FIGS. 1A-C are drawn to anions, and FIGS. 1D-F are drawn to cations, and wherein FIG. 1A and FIG. 1D show the spontaneous absorption of anions and cations, respectively, using the micro-scale capacitive-faradaic adsorbing fuel cells; FIG. 1C and FIG. 1F show O₂-induced and H₂-induced adsorption of anions and cations, respectively using the micro-scale capacitive-faradaic adsorbing fuel cells; and FIG. 1B and FIG. 1E show the H₂-induced and O₂-induced desorption of anions and cations, respectively, using the same.

The CFFCs are made of porous conducting particles, such as, without limitation, activated carbon, carbon aerogels, carbon nanotubes, and the likes, in a form of granules, powder or fibers (e.g. carbon felt, paper or fleece) loaded with a mixture or/and alloy of nano- or/and micro-scale particles of mono-functional or/and bi-functional catalyst (e.g., metallic platinum; Pt metal) suitable for both hydrogen oxidation (HOR) and oxygen reduction (ORR) reactions (see, Eq. 1 and Eq. 2 below, respectively), or suitable for oxidation and reduction of other fuels or oxidizing agents that can be used in the process

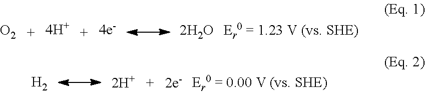

In the context of embodiments of the present invention, the term “reductant” is used interchangeably with the term “fuel” and refers to a substance that can donate electrons in a redox reaction. According to some embodiments of the present invention, a reductant can be a gas such as H₂, SO₂, H₂S, CO, NH₃, or CH₄, a carbohydrate, a hydrocarbon, an alcohol, a carboxylic acid, a borohydride, hydrazine, ascorbic acid, a particulate solid or dissolved organic substance in wastewater or in solid wastes, and any combination thereof. A reductant gas such as hydrogen can be easily introduced into a reaction chamber, as demonstrated in the Examples section that follows below.

In the context of embodiments of the present invention, the term “oxidant” refers to a substance that can oxidize (take electrons) in a redox reaction. According to some embodiments of the present invention, an oxidant can be, without limitation, a gas such as O₂, O₃, H₂O₂, F₂, Cl₂, NO, and NO₂, an active chlorine species (i.e., dissolved Cl₂, HClO, OCl⁻), combined chlorine species (i.e., NH₂Cl, NHCl₂ or NCl₃), chlorite, chlorine dioxide, chlorate and perchlorate, organic chloramines, a permanganate, a dichromate, and any combination thereof. An oxidant gas, such as oxygen, can be easily introduced into a reaction chamber, as demonstrated in the Examples section that follows below.

In the context of embodiments of the present invention, the term “catalyst” refers to a substance (compound, molecule, complex, enzyme etc.) that can catalyze a redox reaction in the medium near, on or in the CFFCs. According to some embodiments of the present invention, the catalyst is in conductive contact with the conductive porous particles, and can be in physical contact or not. In embodiments wherein the catalyst is not in physical contact with the particles, it can be suspended in the medium and be separated from the particles by a conductive membrane. Exemplary catalysts include metallic transition metals (e.g., platinum), natural or designed enzymes (e.g., glucose oxidase; GOx or GOD), viable or non-viable microorganism cells, bacteria, archaebacteria, cyanobacteria, firmicutes, proteobacteria (e.g., Clostridium butyricum, Shewanella, Geobacter, Haloferax volcanii, Natrialba magadii, Geothrix fermentans, Arcobacter, Spirulina platensis, Clostridium butyricum, Rhodospirillum rubrum), yeasts, eucaryotic algae, and mixed communities of microorganisms.

In the exemplary embodiments depicted in FIG. 1A-F, the CFFC particles comprise the capacitive electrode (the activated carbon) and the faradaic electrode, which is the Pt metal. Desalination of anions starts with their spontaneous adsorption by the AC part of CFFC, as shown in FIG. 1A.

The adsorption capacity for anions and selectivity to specific types of anions of the CFFCs, according to embodiments of the present invention, can be enhanced using surface modification thereof by special functional groups (e.g., amine groups) or via other modifications on the particle surface, or/and introduction of other materials (e.g., pseudocapacitive materials) into the structure of CFFCs.

The term “pseudocapacitive material” is used herein as it is used in the field of electrochemistry, and include, without limitation, transition metal oxides, transition metal sulfides, conductive polymers Exemplary pseudocapacitive materials suitable for use in the context of embodiments of the present invention, include ruthenium oxide (RuO₂), iridium oxide (IrO₂), iron oxide (Fe₃O₄), manganese oxide (MnO₂), titanium sulfide (TiS₂), Co₃O₄, cobalt sulfides (CoSₓ) nickel sulfides (NiSₓ), metal nitrides (TiN, VN, MON, layered double hydroxides (LDHs) (e.g., CoAl-LDH on Indium-Tin Oxide substrate, graphene nanosheet/NiAl-LDH) polypyrrole, polyaniline, poly (styrene sulfonate), poly (3,4-ethylenedioxythiophene) polythiophene polymethyl methacrylate, phospahe-based nanomaterials (e.g., LiFePO₄, Na₃V₂(PO₄)₃) and any combination thereof.

CFFC, once saturated with anions, is regenerated in the second process step by hydrogen gas, as shown in FIG. 1B. Oxidation of H₂ on Pt, which acts now as a faradaic anode, results in production of protons and electrons that travel to the activated carbon, which acts now as the capacitive cathode of the micro-scale electrochemical reactor. Accumulation of electrons results in repulsion of previously adsorbed anions into the aqueous solution which is acidified during the regeneration step due to H⁺ production on the Pt electrode of the micro-fuel cell. The regenerated CFFCs are utilized again for the adsorption of anions in the next adsorption-desorption cycle. Now the adsorption of anions requires dissolved oxygen in the treated water. As shown in FIG. 1C, reduction of dissolved oxygen on Pt particles, which act as a faradaic cathode, results in consumption of electrons and protons and production of water (or hydrogen peroxide, not shown in FIGS. 1A-F). The electrons are supplied from the activated carbon part of the CFFC which acts as a capacitive anode. To maintain its neutrality, the anions are adsorbed into the activated carbon from the treated aqueous solution (FIG. 1C). The process is accompanied by a decrease in water acidity due to consumption of protons (see, Eq. 1 below). To minimize the adsorption of hydroxyl ions (OH⁻) instead of the target anions by the CFFCs, the pH of the treated water can be adjusted and buffered with the suitable pH-buffering compounds (carbonate, phosphate or other buffers).

Desalination of cations is shown in FIGS. 1D-1F. Similarly to the adsorption of anions, the first adsorption step of cations by the CFFCs occurs spontaneously without an involvement of oxidation-reduction processes (FIG. 1D). The AC part of the adsorbing cells should be properly modified (e.g. via introduction of carboxylic or sulfonic groups, or/and other types of functional groups, or/and via the introduction of other functional materials (e.g., pseudocapacitive) into the structure of CFFCs) to increase the cations adsorption capacity (and selectivity, if needed). Desorption of cations during a brine formation and regeneration of CFFCs is achieved by the oxygen reduction reaction on the Pt cathode (FIG. 1E). The regenerated CFFCs adsorb the next portion of cations with the aid of oxidation of hydrogen gas on the Pt electrode of the CFFCs that acts now as a faradaic anode (FIG. 1F). To minimize the adsorption of protons (H⁺) instead of the target cations by the CFFCs, the pH of the treated water can be adjusted and buffered with the suitable pH-buffering compounds (carbonate, phosphate or other buffers).

Overall, the process consumes oxygen (the oxidant) and hydrogen (the fuel) to desalinate the ions; hence, the process resembles the desalinating in a fuel cell. On the other hand, the herein-disclosed process utilizes capacitive electrodes, and this they it can be considered as a type of CDI process.

The proposed desalination process using the CFFCs can be done in batch, continuous stirred (CSTR), fixed-bed and other types of reactors normally applied in adsorptive water treatment processes. The treated water and the brine solution can be enriched with dissolved oxygen and hydrogen gases via bubbling, membrane contactors or other state-of-the-art techniques.

Potential advantages of the CFFCs process are: (1) the process can be utilized for separation of all types of anions and cations (appropriate carbon modification might be required); (2) the process can be performed in any type of adsorption reactors; (3) desalinating hybrid capacitive-faradaic micro-scale fuel cells do not require any wiring as opposite to CDI, previously proposed desalinating fuel cells and battery electrode desalination processes; (4) the regeneration of the CFFCs does not require any concentrated solutions of acids, bases or salts; and (5) the hydrogen required for the process can be produced in situ using hydrogen generators and air can be utilized as the oxygen source.

### Additional Implementations of the Invention:

In its basic embodiment the CFFC technology produces concentrate stream in parallel to treated water, which resembles the ion-exchange and other adsorption processes. However, the technology can be expanded towards concentration of the ionic pollutant coupled to its catalytic oxidation or/and reduction by oxygen and hydrogen gases, respectively. For instance, nitrate ions can be converted to environmentally friendly nitrogen gas (the desired product) and ammonia (normally unwanted product) using bimetallic (e.g., Pd—Cu, Pd—Sn, Pd—In, Pt—Cu, Pt—In) or monometallic catalysts (e.g., Pt, Pd, Ru, Fe) supported on different types of substrates (e.g., aluminum oxide, cerium oxide, zirconia oxide) including (activated) carbons [Martinez et al., 2017; Shukla et al., 2009]. Nitrite ions can be hydrogenated as well into nitrogen (and ammonia) which is normally done using Pd catalysts. Recent studies show that Re—Pd catalysts can be implemented for the hydrogenation of perchlorate ions into chloride ions in aqueous solutions at ambient temperature [Hurley and Shapley, 2007]. Chen et al., (2010) showed that bromate ions can be hydrogenated on Pd catalyst into bromide ions. Consequently, within the H₂-induced regeneration stage of the CFFCs treatment of anionic pollutants (e.g., nitrate and/or perchlorate ions) they can be reduced via hydrogenation if suitable catalyst is present in the CFFCs structure. For example, CFFCs that comprise monometallic catalysts (e.g., Pd or Pt) or bimetallic catalysts (e.g., Pd—Cu, Pt—Cu) can be applied for CFFCs process in which nitrate or/and nitrite or/and perchlorate ions or/and bromate ions are adsorbed by CFFCs at the first treatment step and reduced within the second treatment step which combines simultaneous H₂-induced desorption of these ions and their simultaneous hydrogenation to N₂, Cl⁻ and Br⁻ ions (respectively).

Ferric ions can be reduced by the CFFCs into the ferrous form. Copper cations can be reduced into the elemental copper by hydrogen (or other fuel) within the water treatment step, and the elemental coper can be oxidized by oxygen (or other oxidant) into the copper cations within the regeneration of the CFFCs. Similarly nickel and other cations of metals can be removed from water and wastewater by converting the same into an insoluble form by the CFFCs. The removal of the insoluble forms can be effected by filtration, sedimentation and/or re-solubilization during the regeneration step.

Metal catalysts can be introduced into the CFFCs using numerous state-of-the-art methods [Mehrabadi et al., 2017], e.g. impregnation with precursors solutions followed by reduction in hydrogen atmosphere or by other reducing agents (e.g. borohydride, hydrazine, ascorbic acid); precipitation deposition; sputtering; (3) electrochemical deposition; chemical vapor deposition; spray-, dip- or brush-coating with inks containing catalysts' particles (e.g. Pt, Cu, Ir, Pd blacks) and binders (e.g. perfluorosulfonic acid (PFSA) polymer (Nafion)).

### Mono- and Multi-Component Catalysts for CFFCs:

The operation of CFFCs-based water treatment process requires catalysts for hydrogen (or other fuel) oxidation and oxygen (or other oxidant) reduction reactions. These catalyst in the CFFCs can be a monometallic catalyst (e.g., Pt) or multi-component catalyst (e.g., Pd and Ir) formulated as an alloy or as a mixture of particles of different types of materials loaded on the carbon part of the CFFCs. Non-noble metal catalysts for oxygen (or other oxidant) reduction reaction [Gewirth et al., 2018] and hydrogen (or other fuel) oxidation reaction [Chen et al., 2014] can be implemented in CFFCs. Catalysts of the CFFCs can also include another heterogeneous or homogeneous catalytic materials for the secondary function of CFFCs (e.g. oxidation or reaction of species). For example, CFFCs with Pd—IrO₂—Cu catalysts can be used for separation and hydrogenation of nitrate or/and nitrite or/and bromate or/and perchlorate ions; perrhenate ions (ReO₄⁻) can be into perchlorate solution during the treatment with CFFCs that comprise Pd or Pt catalyst to reduce ClO₄⁻ into the Cl⁻ ions. Alternatively Re—Pt—CFFCs can be used for perchlorate separation and hydrogenation into the chloride ions.

### Other Types of CFFCs:

In its basic embodiment the new CFFC technology utilizes micro-scale or macro-scale electrochemical cells that comprise one capacitive and one faradaic electrode. In other embodiments the performance of the CFFCs can be improved by modification of capacitive electrode with materials (e.g., metal oxides MnO₂, RuO₂, V₂O₅) to induce faradaic reactions that result in intercalation of ions into the CFFCs [Yu et al., 2019]. Many types of these materials can be found in relevant literature [Suss and Presser, 2018].

CFFCs with Modified Carbons:

The adsorption capabilities and selectivity of activated carbon (AC) of the CFFCs to different ions depend strongly on nature and amount of surface functional groups on the surface of the AC. A wide variety of surface functional groups can be introduced to the AC. For instance, oxygen contains functional groups (phenolic, quinones, carboxylic, ketone, etc.) [Mangun et al., 1999, Carabinero et al., 2011]. In addition, functional groups contain nitrogen (pyrrole, pyridine, and etc.) sulfur (sulfide, thiophenol, and etc.) and halogens can be introduced to the surface of AC [Mangun et al., 1999].

Sulphonated and carboxylated carbons can be prepared for CFFCs aimed at cations removal using treatment of carbons in sulfuric acid [Kang et al., 2013] and nitric acid [Moreno-Castilla et al., 1995], respectively. Oxygen-containing functional groups can be introduced also by oxidative treatment with hydrogen peroxide, ammonium peroxydisulfate and other oxidants (e.g., air oxygen). The CFFCs can be functionalized by chelating agents (e.g., carbamates, β-diketones, amino acids, aldoxime, aminophosphonic acid, azo-triphenylmethane dyes, 8-hydroxyl quinolinol) for improved removal of ions [Sud, 2012].

To improve adsorption characteristics of CFFCs for anions (e.g. nitrate, perchlorate, bromate, nitrite) carbons can be loaded with functional groups. The most known are amine groups that can be formulated on carbons using numerous state-of-the-art techniques [Houshmand et al., 2011]: heat treatment in ammonia atmosphere, impregnation with compounds containing amine groups (e.g., polyethyleneimine, alkanolamines, polyamines); silylation with aminosilans, and others [Houshmand et al., 2011].

### Water Treatment System:

According to some embodiment of the present invention, there is provided a system for decreasing an amount of ions in a liquid medium, which includes, without limitation:
a first chamber that contains the liquid medium for treatment, and a plurality of conductive porous particles that comprise a catalyst in conductive contact with said particles, according to some embodiments of the present invention. The catalyst, as described hereinabove, is capable of catalyzing an oxidation reaction upon exposure to a reductant in the medium and/or a reduction reaction upon exposure to an oxidant in the medium.

The first chamber is configured for introducing the reductant or the oxidant into the medium, and includes at least some of the following means, including tubing, flow meters, values and gauges, bubblers for gaseous reductant/oxidant, stirrers for other forms of reductant/oxidant, and the likes.

The system may further include an optional filtering unit (a filter) for separating the conductive porous particles from the medium. The filter can be in the form of a cage that contains the particles, which rests inside the first chamber and can be taken out of the medium. Alternatively, the filter can be a form of sintered glass bottom of a glass column, wherein the particles remain on the filter when the medium is drained from the column. The invention is not limited to one form of filtering unit or another, and any form that allows the separation of the particles from the medium is contemplated.

The system may further include a second chamber for use in a regeneration step using a regeneration solution once the particles are separated from the treated medium. The second chamber can be configured much like the first chamber in terms of including means for introducing the reductant or the oxidant into the regeneration solution once the particles have been placed therein.

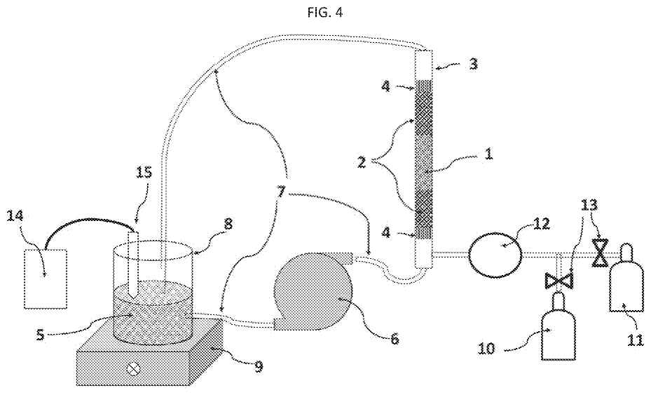

It is noted that the first chamber can act as a second chamber if the treatment medium/electrolyte is removed therefrom, and the regeneration solution takes its place. In other words, the system can be fully functional with a single chamber, including for regeneration. It is further noted that the system can also be configured with a reservoir for the treated medium and a separate flow chamber, or column, for containing the CFFCs and effecting the redox reaction therein while flowing the medium in a cycle, essentially as illustrated in FIG. 4.

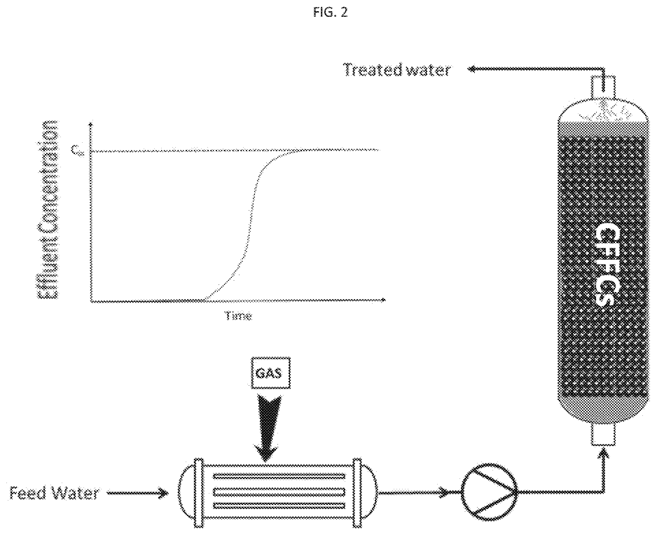

FIG. 2 presents a schematic illustration of a water treatment system, based on the method of water treatment according to some embodiments of the present invention, wherein O₂-induced (gas) adsorption of anions on the micro-scale capacitive-faradaic adsorbing fuel cells (CFFCs) in the fixed-bed reactor.

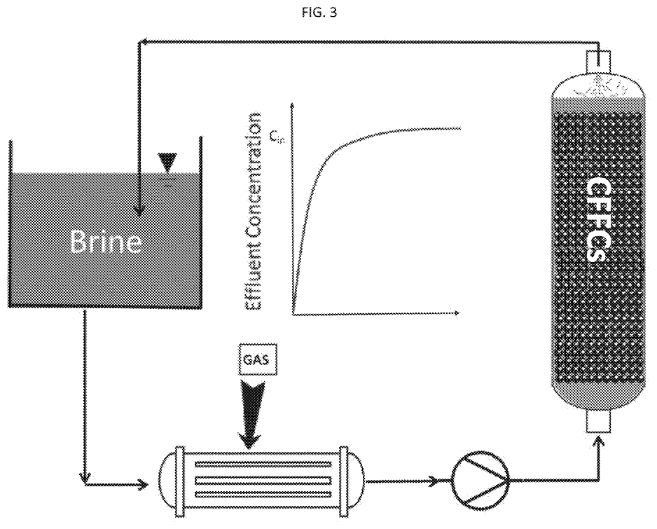

FIG. 3 presents a schematic illustration of a water treatment system based on the method, according to some embodiments of the present invention, wherein H₂-induced (gas) desorption of anions from the micro-scale capacitive-faradaic adsorbing fuel cells (CFFCs) in the fixed-bed reactor.

FIG. 4 is a schematic illustration of a batch-mode laboratory system applied in experiments conducted on micro-scale CFFCs loaded with Pt catalyst (used in Examples 1-4), showing batch-mode laboratory system 20, applied in experiments, showing micro-scale CFFCs 1 compacted between glass spheres 2 in column 3 equipped with porous sintered glass discs 4, allowing medium 5 to recirculate by pump 6 via tubing 7 between chamber 8, stirred with stirrer 9, and column 3, into which fuel gas or oxidant gas are supplied from gas cylinders 10 and 11 equipped with flow rate controller 10 and gas pressure regulators 13, whereas the pH of medium 5 is monitored and recorded by pH meter 14 equipped with a glass pH probe 15.

### Hybrid Electrochemical Cell:

According to some embodiment of the present invention, there is provided a hybrid electrochemical cell which includes, without limitation:
a faradaic half-cell that includes a first electrode in contact with an electrolyte, a catalyst as described herein, and means for introducing a reductant or an oxidant into said faradaic half-cell, as described for the water-treatment system;
a capacitive half-cell that includes an electrode in contact with a second electrolyte and the plurality of conductive porous particles, as described herein, as well as means for introducing a reductant or an oxidant, as described for the water-treatment system; and a separator (e.g., a membrane) or a solid electrolyte (e.g., ion exchange membrane) for separating the faradaic half-cell from said capacitive half-cell. The separator can be in any form, shape and material suitable for use as a separator in electrochemical cells, as these terms are used in the field of electrochemistry.

The two cells can contain essentially the same electrolyte, or alternatively, each half-cell can contain two different electrolytes, or the solid electrolyte can be the only form of the electrolyte in the system.

The electrolyte can be an aqueous electrolyte, an ionic liquid, a molten salt, an organic electrolyte, and an organic solvent that comprises an organic salt, as described hereinabove for the term “medium”.

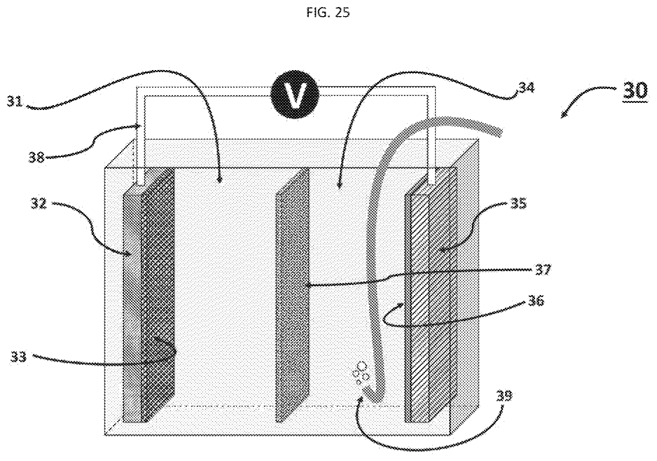

FIG. 25 is a schematic illustration of a hybrid electrochemical cell, according to some embodiments of the present invention, showing hybrid cell 30, which includes capacitive half-cell 31 equipped with electrode 32 coated with a layer of conductive porous particles 33, and faradaic half-cell 34, equipped with electrode 35 having a catalyst layer 36 and means for introducing reductant/oxidant 37, and further including separator 38 positioned between the two cell halves, which are electrically connected by electric bridge 39.

Example 3, in the Examples section that follows below, presents a series of experimental studies directed to the generation and conversion of electrochemical energy, according to some embodiments of the present invention.

Thus, according to another aspect of some embodiments of the present invention, there is provided a method for electrochemical energy conversion and storage, which is effected by:
providing the hybrid electrochemical cell as provided herein and described hereinabove, and
introducing a reductant or an oxidant into the faradaic half-cell, thereby generating electrochemical energy.

Optionally, the method further includes, subsequent to the generation of electrochemical energy, re-introducing reductant/oxidant as follows:
if a reductant was introduced into the faradaic half-cell, then introducing an oxidant to the electrolyte of the faradaic half-cell, or
if an oxidant was introduced, then introducing a reductant thereto,
thereby converting said electrochemical energy.

It is expected that during the life of a patent maturing from this application many relevant micro-scale and macro-scale capacitive-faradaic fuel cells (CFFCs) will be developed and the scope of the term CFFC is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method”, used interchangeably herein, refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

As used herein, the term “treating” includes “substantially improving the quality of”, slowing or reversing the progression of contamination, substantially ameliorating contamination or substantially preventing the contamination.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion. The below-described study was dedicated to the proof of the proposed concept for water desalination, wherein perchlorate anion was selected as the model ionic pollutant.

### Example 1

### Basic Proof of Concept

### Preparation of Micro-Scale CFFCs:

Three types of carbons were used to prepare the CFFCs: (1) Lewatit AF5 (Lanxess) microporous carbon; (2) Norit SX Ultra activated charcoal (Sigma-Aldrich), and granular activated charcoal (CH104, mesh size 12-20, Spectrum). The Lewatit AF5 was loaded with Pt (0.1- to 5.0 wt. %). First, all carbons were dried overnight at 60° C. Next, the carbons were loaded with aqueous solutions of H₂PtCl₆ (Sigma-Aldrich). The impregnation of carbons was done using the incipient wetness impregnation technique. After the impregnation, the carbons were dried overnight at room temperature, afterwards in the oven in air atmosphere at 150° C., and calcinated in nitrogen atmosphere at 290° C. for 2 hours. Finally, the carbons were exposed to the reductive hydrogen gas atmosphere (12 hours, 300° C.) to reduce the metal ions to elemental Pt.

### Perchlorate Adsorption-Desorption Experiments:

Sodium perchlorate (Sigma-Aldrich, analytic reagent) was used to prepare perchlorate solutions. For the preparation of the synthetic groundwater contaminated with perchlorate the bottled spring water with the composition shown in Table 1 (measured in this study) was used. Table 1 below presents composition of spring water with added sodium perchlorate used in this study.

TABLE 1

| Component | Concentration | Units |
|---|---|---|
| Alkalinity | 184.7 | mg/l as |
| | | CaCO₂ |
| *ClO₄_{^{−}} | 200 | mg/L |
| NO₃_{^{−}} | 14 | mg/L |
| NO₂_{^{−}} | 0 | mg/L |
| Cl⁻ | 21 | mg/L |
| Ca⁺² | 48 | mg/L |
| Mg⁺² | 19 | mg/L |
| *Na⁺ | 53.3 | mg/L |
| K⁺ | 3 | mg/L |
| SO₄⁻² | 8.4 | mg/L |
| SiO₂ | 8 | mg/L |
| pH | 7.94 | [—] |
| TOC ** | 0.4 | mg/L |

*Perchlorate was added as sodium perchlorate to simulate the pollution.
** TOC = Total organic carbon

### Batch Mode Experiments:

Batch mode experiments, using Pt-loaded CFFCs made of granular activated charcoal loaded with 0.1% Pt were conducted on NaClO₄ solution (300 ml, [ClO₄⁻]₀=200 mg/L, 7.5 g_{CFFCs}/L) in deionized water. The system like the one shown in FIG. 4 was used in these experiments.

The experiment comprised six adsorption-desorption cycles where every cycle comprised two steps: (i) adsorption of perchlorate ions forced by oxygen reduction reaction on CFFCs (air was bubbled through the suspension using the sintered glass diffuser at 180-220 mL/min flowrate), and (ii) desorption of perchlorate ions using the hydrogen oxidation reaction on CFFCs. In this experiment the water samples were periodically withdrawn from the reactor and analyzed for ionic composition. The pH of perchlorate solutions was monitored continuously using 914 EC/pH meter equipped with 6.0228.000 glass electrode (Metrohm, Switzerland).

### Fixed-Bed Experiments:

Fixed-bed experiments were conducted using a glass column (internal diameter 22.1 mm, length 25 cm) filled with 46 grams of CFFCs that were prepared from Lewatit AF5 with Pt loading of 5% wt. To prevent an escape of micro-cells from the column both ends were closed by adapters equipped with porous sintered glass discs (pore size 100-160 μm). Sodium perchlorate solution in deionized water with the concentration of 10 mgClO₄⁻/L was pumped through the column in upward direction at a flow rate of 10 mL/min using an automatic titrator (Titrino718stat, Metrohm). The experiment had four stages: (1) spontaneous adsorption of ClO₄⁻ until a breakthrough of perchlorate from the column; (2) H₂-induced regeneration of ClO₄⁻ into deionized water (three batches of 200 mL); (3) O₂-induced adsorption of ClO₄⁻; and (4) second H₂-induced regeneration of the column. In O₂-induced operations the air was bubbled through the NaClO₄ solution in a separate column to saturate the solution with a dissolved oxygen. The pH in column's effluent was monitored continuously during the experiment. The regeneration of CFFCs was done by recirculation (50 mL/min) of deionized water (200 mL) between the column and a stirred holding vessel through which the H₂ gas was bubbled at a flow rate of 150 mL/min. Samples of the effluent were withdrawn periodically during every experimental step and analyzed for perchlorate concentration.

Concentration of perchlorate ions was determined using Metrohm 930 compact IC flex ion chromatograph operated with Metrosep A Supp 5 Guard/4.0 column (flow rate: 0.7 mL/min; temperature: 45° C.; pressure: 2.1 MPa; carbonate eluent (standard eluent), sodium carbonate: 3.6 mmol/L). Metrosep A supp7 250/4 column was applied for the determination of Cl⁻, NO₃⁻, NO₂⁻ and SO₄²⁻ anions. Concentrations of metal cations (Ca²⁺, Mg²⁺, Na⁺, K⁺) were determined using the ICP-MS (Thermo scientific iCAP 6300 ICP spectrometer). Morphology of CFFCs was examined by the high-resolution scanning electron microscopy (Ultra-Plus FEG-SEM, Zeiss).

### Results and Discussion:

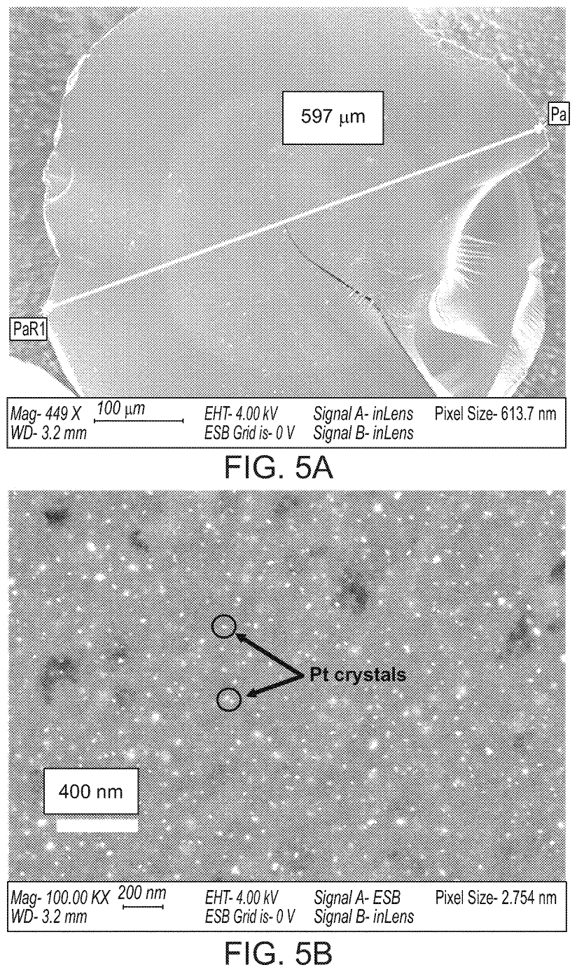

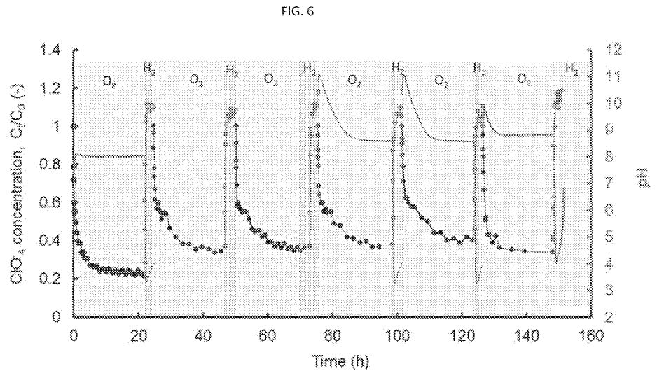

FIGS. 5A-B show SEM images of CFFCs prepared from Lewatit AF5 loaded with Pt catalyst (5% wt). As can be seen in in FIGS. 5A-B, nano-scale Pt particles are uniformly distributed in Lewatit AF5 spheres of the CFFCs, whereas the last cycle shown in FIG. 6 was conducted with groundwater spiked with NaClO₄⁻ solution.

FIG. 6 represents the results of batch-mode adsorption-desorption experiment conducted on sodium perchlorate solution using the CFFCs that comprised granular activated charcoal particles loaded with Pt (0.1% by weight) catalyst.

As can be seen in FIG. 6, the addition of CFFCs into the aerated sodium perchlorate solution resulted in gradual decrease of ClO₄⁻ concentration from 212 mg/L to about 40-80 mg/L and a very sharp increase in pH from 7.94 to 10<pH<11. Bubbling of hydrogen gas in the second step of every cycle resulted in prompt release of perchlorate ions from the CFFCs and after approximately 40 minutes its concentration approached the initial value (approximately 200 mg/L). As expected, hydrogen oxidation reaction by CFFCs resulted in a pH decrease in the sodium perchlorate solution from 10.61 to about 3.0.

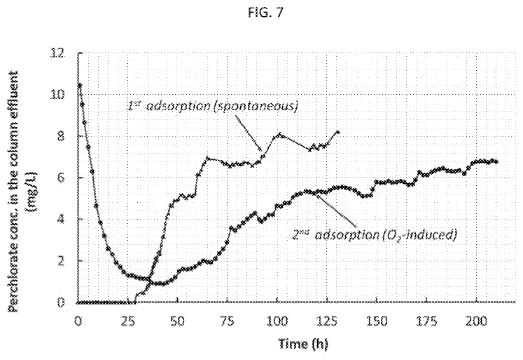

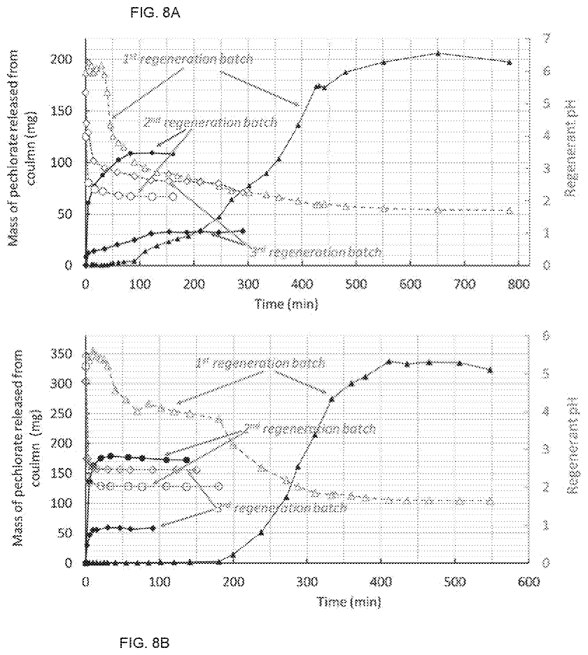

Results of perchlorate adsorption-desorption experiments conducted with a column packed with CFFCs made of Lewatit AF5 particles loaded with Pt (5% wt.) catalysts are presented in FIG. 7 and FIGS. 8A-B. The main purpose of these tests was to demonstrate that the proposed process can be performed in packed bed (fixed bed) reactors. During the first (spontaneous) adsorption operation the perchlorate concentration in the column effluent remained zero for 29 hours (17.4 liters of a 10 mgCLO₄⁻/L solution). Afterwards the ClO₄⁻ concentration started to increase and reached 8.2 mg/L after 130 hours of operation. As follows from the shape of the breakthrough curve the mass transfer zone in the column was very wide, which is a result of insufficient retention time of perchlorate solution in the column.

The reasons for the fluctuations in [ClO₄⁻] observed in FIG. 7 are unclear. During the first (spontaneous) adsorption operation 377.44 mg of ClO₄⁻ were adsorbed by CFFCs as was calculated from the area above the breakthrough curve in FIG. 7. FIG. 8A represents the results of the first H₂-induced operation of perchlorate ions desorption that was performed just after the spontaneous ClO₄⁻ adsorption was completed. Desorption was done by three steps; within each step 200 mL of deionized water purged with H₂ gas were recirculated through the column.

As shown in FIG. 8A, concentration of perchlorate ions in regeneration solution reached maximum value in every operation. Thus, within the first desorption step the concentration of ClO₄⁻ gradually increased to about 1500 mg/L, the pH decreased from 5.96 to 1.71 and the desorption ceased after about 600 minutes. To desorb more ClO₄⁻ the regeneration solution had to be replaced with a fresh portion of deionized water. Within the second desorption step the concentration of ClO₄⁻ gradually increased to about 595 mg/L and the pH decreased to 2.13 after 160 minutes. The third regeneration step resulted in [ClO₄⁻]=290 mg/L and pH=2.26. It was not possible to release all perchlorate ions into the single batch of deionized water due to the decrease in the pH in the regeneration solutions that occurred due to reaction depicted in Eq. 2. To increase the efficiency of the regeneration process it can be conducted at higher H₂ pressures in the regeneration solution to facilitate the hydrogen oxidation reaction on CFFCs. Overall 349 mg of ClO₄⁻ ions were released in the first desorption operation (e.g. in all three steps) which corresponds to 92.5% of column regeneration.

During the second adsorption operation that was induced by the O₂ gas (FIG. 7) 583 mg of ClO₄⁻ were adsorbed by CFFCs after 210 hours. This value is approximately 1.5 times higher than the adsorption capacity achieved in spontaneous adsorption. In spite the fact that the full adsorption capacity of CFFCs was not exploited in both adsorption experiments, it is reasonable to state that observed higher adsorption capacity for perchlorate ions in O₂-induced experiment is due to the capacitive ClO₄⁻ adsorption that occurred in addition to the spontaneous perchlorate adsorption by Lewatit AF5. The mass transfer zone of the second adsorption operation was even wider than in spontaneous adsorption (FIG. 7). This can be explained by insufficient rate of oxygen reduction reaction inside the CFFCs column. The O₂-induced adsorption depends strongly on O₂ concentration in the treated solution and kinetics of the oxygen reduction reaction in the column. Obviously, the process of O₂-induced adsorption of ClO₄⁻ using a fixed bed reactor requires detailed investigation and optimization in future studies.

The results of the second three-step ClO₄⁻ desorption operation are shown in FIG. 8B. The behavior of the pH and the perchlorate concentration in each step during the second desorption was similar to the first desorption experiment. Overall 566 mg of the perchlorate ions were desorbed which corresponds to 97% recovery of the column in the second adsorption-desorption cycle.

### Example 2

### Nitrate Separation/Hydrogenation

### Introduction

The very promising technology for nitrate reduction is the catalytic hydrogenation. This process is described by stoichiometric equations Eq. 3 and Eq. 4. The main products of NO₃⁻ hydrogenation are nitrogen gas (which is the desired product), nitrite ions and ammonia (both are unwanted toxic by-products).

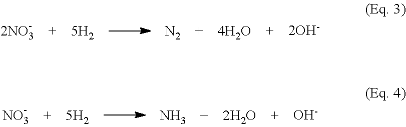

The most effective bimetallic catalysts applied in nitrate hydrogenation processes comprise a noble metal (mostly palladium or platinum) and a transition metal (such as copper, tin, or indium).

In this example it is shown that the CFFC process operated with cells loaded with multi-functional Pt—Cu catalyst can be used for separation and hydrogenation of nitrate ions.

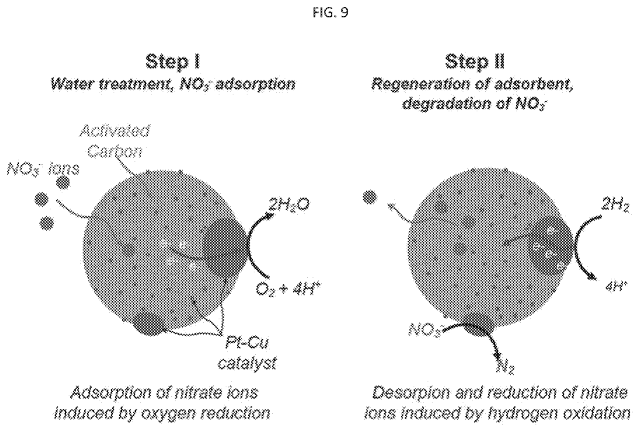

FIG. 9 presents a schematic illustration of the principle of a two-step process for nitrate ions separation and hydrogenation using microscale capacitive-faradaic fuel cells (CFFC).

As can be seen in FIG. 9, at the first step (Step I), described by Eq. 5 below, the water contaminated with NO₃⁻ is saturated with air (using bubble column or membrane contactor) and treated by CFFCs to separate the nitrate ions. The ORR on bifunctional Pt—Cu catalyst results in depletion of electrons in activated carbon of CFFC and adsorption of NO₃⁻ ions (Step I in FIG. 9).

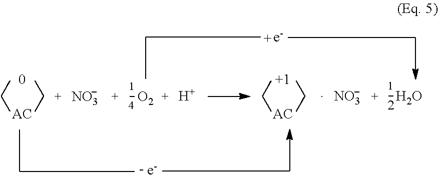

where:

$$〈 \begin{matrix}0 \\ AC\end{matrix} 〉$$

is uncharged capacitive activated carbon electrode of the CFFC;

$$〈 \begin{matrix}+ 1 \\ AC\end{matrix} 〉 .$$

NO₃⁻ is capacitive activated carbon electrode of the CFFC that lost one electron and electrosorbed one NO₃⁻ ion.

As can further be seen in FIG. 9, the second step of the process is performed in a separate portion of water (the regeneration solution). To initiate the release and hydrogenation of NO₃⁻ ions the water is saturated with the hydrogen gas. The HOR on Pt results in release of NO₃⁻ ions as described by Eq. 6:

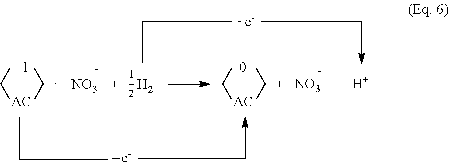

In parallel to desorption the nitrate ions are reduced on the Pt—Cu catalyst of the CFFCs (Step II in FIG. 9, Eq.1 and Eq. 2).

### Preparation of Micro-Scale CFFCs:

The CFFCs were prepared from Lewatit AF5 microporous carbon. First, 20 grams of Lewatit AF5 were dried overnight at 60° C. Next, the carbon was impregnated with 22.4 ml of H₂PtCl₆ solution (44.64 mgPt/ml) to achieve a Pt loading of 5% (w/w). After the impregnation, the carbons were dried overnight at room temperature, afterwards in the oven in air atmosphere at 60° C., and calcinated in nitrogen atmosphere at 290° C. for 2 hours. Finally, the carbons were exposed to the reductive H₂ atmosphere (12 hours, 300° C.) to reduce the metal ions into the elemental Pt metal. To formulate the CFFCs loaded with bimetallic 5% Pt-1% Cu catalyst (weight percent relative to Lewatit AF5) the Pt-loaded Lewatit AF5 (5% Pt w/w) was impregnated with Cu(NO₃)₂·3H₂0 solution (22.4 ml, 8.94 mgCu/ml). Next, the carbon was dried, calcinated and reduced in H₂ atmosphere as described previously. Prior to use all CFFCs were washed with deionised water and dried at room temperature.

### Experimental System:

FIG. 4 is a schematic illustration of a batch-mode laboratory system applied in experiments conducted on micro-scale CFFCs loaded with Pt catalyst (used in Examples 1-4). The CFFCs in the system shown in FIG. 4 were compacted between the glass spheres in a glass column (internal diameter—22.1 mm, length—25 cm) equipped with sintered glass discs at the inlet and the outlet. Aqueous solutions of NaClO₄, NaNO₃, CuCl₂, aqueous solution of Cu²⁺, Ni²⁺, Cd²⁺, Fe³⁺, Ca²⁺, Mg²⁺ and Zn²⁺ ions or contaminated groundwater was recirculated between the stirred glass beaker and the column using the peristaltic pump (flow-rate 100 ml/min). Hydrogen gas (produced by PG Plus, LNI Schmidlin hydrogen generator) or pressurized air were introduced into the influent at the bottom part of the column via the T-shape connector. The flow rates of gases (180-220 ml/min) were controlled using the mass flow meters (0-1000 ml/min, Aalborg). The pH was monitored continuously using the 914 EC/pH meter equipped with the 6.0228.000 glass electrode (Metrohm, Switzerland).

The batch mode nitrate separation/hydrogenation experiments were conducted using a system like the one shown in FIG. 4 with NaNO₃ solutions in deionized water (300 ml, initial nitrate ions concentration—300 mg NO₃/l). The NaNO₃ solution was recirculated (60 ml/min) between a stirred beaker and the column by a peristaltic pump. Air, N₂ and H₂ gases were supplied by compressor, gas cylinder, and hydrogen generator (respectively) into the column via the sintered glass disc. The concentration of CFFCs in all experiments was 23.33 g/L (overall 7 grams of CFFCs in the system). Every experiment comprised five consecutive cycles while every cycle included two steps. Within the first step of nitrate adsorption the NaNO₃ was continuously purged with air (100-200 ml/min at standard conditions). At the end of the nitrate separation step the CFFCs were separated from the resulting NaNO₃ solution by filtration. Next, the second step aimed at nitrate desorption/hydrogenation was initiated. The CFFCs from the first step were dispersed in deionized water (300 ml) and the H₂ gas was bubbled through the stirred suspension. The pH during the pH-controlled experiments was maintained by an automatic addition of 0.05 M HCl solution using the Titrino 718 state apparatus (Metrohm, Switzerland). Periodically 2 ml samples were withdrawn from the system and analysed for NO₃⁻ and NO₂⁻ concentrations. The final concentration of ammonium ions was determined only in experiments that were conducted with CFFCs loaded with Pt—Cu catalyst. The nitrogen yield was estimated from the N mass balance assuming that the only products were nitrogen, nitrite and ammonium.

The pH was monitored continuously in every experiment using the 914 EC/pH meter equipped with 6.0228.000 glass electrode (Metrohm, Switzerland). The flow rates of air and H₂ gases were controlled using the mass flow meters (0-1000 mL/min, Aalborg). Concentrations of nitrate and nitrite ions were determined using the Metrohm 930 compact IC flex ion chromatograph operated with Metrosep A supp7 250/4 column. The ammonia concentration was measured by salicylate method as described in [17]. The morphology and composition of CFFCs was examined by a high-resolution field emission Gun SEM ZEISS Ultra Plus equipped with EDS Oxford Instruments (England).

### Results and Discussion:

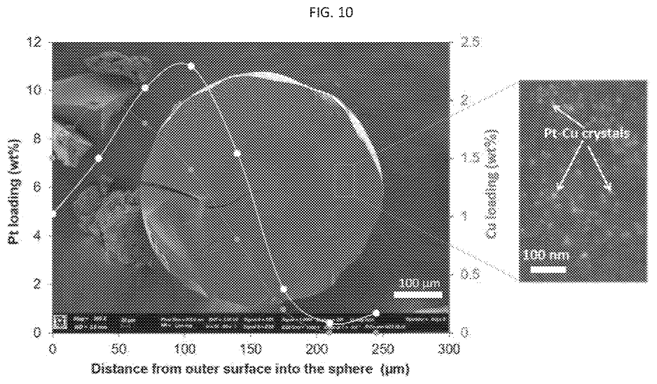

FIG. 10 presents the HR-SEM image of Lewatit AF5 sphere loaded with 5% Pt-1% Cu bimetallic catalyst, and distribution of Pt and Cu loading inside the carbon sphere as determined by the EDS technique.

As can be seen in FIG. 10, the distribution of Pt and Cu was not uniform and maximal concentrations of two metals were obtained at depths of about 100 μm and about 35 μm, respectively.

First, the nitrate separation experiments were conducted using the CFFCs that comprised Lewatit AF5 loaded with Pt (5% w/w) catalyst only.

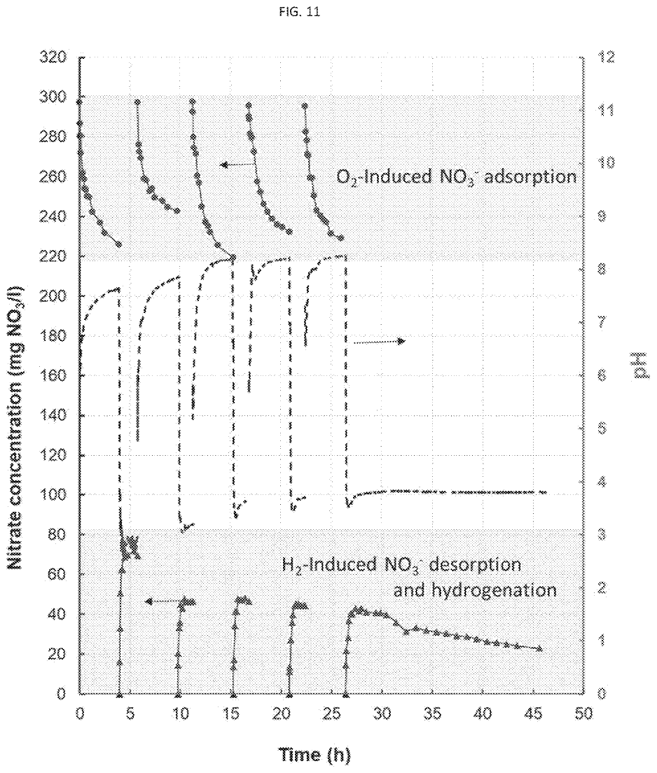

FIG. 11 presents the results of five consecutive cycles of O₂-induced adsorption and H₂-induced desorption/hydrogenation of nitrate ions performed with CFFCs that comprised Lewatit AF5 carbon loaded with Pt catalyst (5% wt).

As can be seen in FIG. 11, after five nitrate adsorption-desorption cycles, within four hours-long separation steps, the NO₃ removal was within a 19-26% range. The regeneration efficiency obtained in 1.5 hours-long desorption steps was between 58 to 98%. The pH in treated solutions increased gradually from initial pH6.0-7.3 to pH7.6-8.2 during the O₂-induced NO₃⁻ separation steps and decreased sharply from pH7.6-8.2 to pH2.7-3.78 within the first minutes of the H₂-induced desorption steps (FIG. 11). This pH behaviour is in agreement with predicted reactions Eq. 5 and Eq. 6.

The H₂-induced desorption step in cycle #5 (FIG. 11) was continued for 20 hours to obtain the rate of nitrate hydrogenation which is possible on the monometallic Pt catalyst. As it appears from FIG. 11, the hydrogenation rate of NO₃⁻ ions on CFFC loaded with Pt metal was as low as 1.16 mg NO₃⁻/l/h.

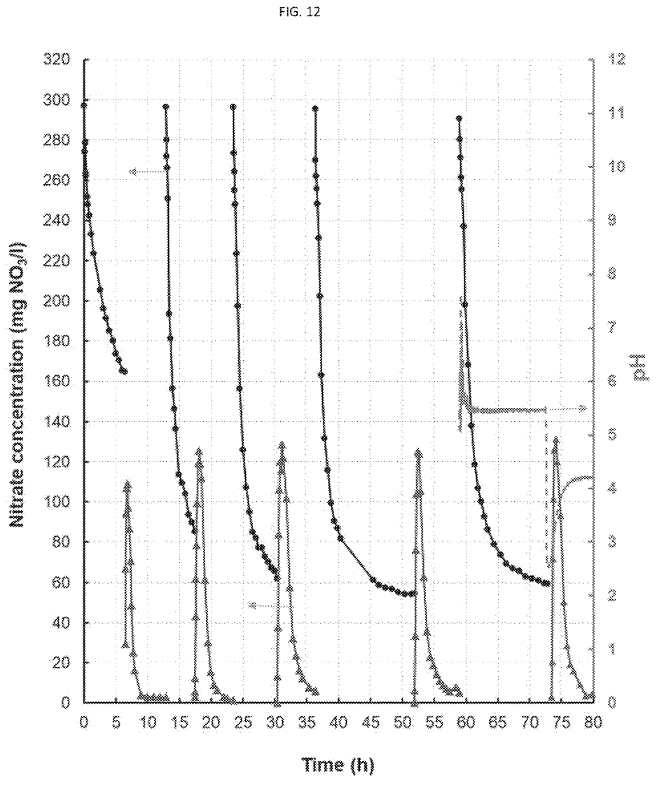

FIG. 12 presents the results of five consecutive cycles of O₂-induced adsorption and H₂-induced desorption/hydrogenation of nitrate ions performed with CFFCs that comprised Lewatit AF5 carbon loaded with 5% Pt-1% Cu catalyst, whereas ●—denotes the nitrate concentration during O₂-induced adsorption, ●—denotes the nitrate concentration during H₂-induced NO₃-desorption/hydrogenation, and the pH (denoted --) is shown only for the last adsorption-desorption cycle.

As can be seen in FIG. 12, the pH of the treated solution was maintained constant at about pH5.5 during the NO₃⁻ adsorption steps. Operation at slightly acidic conditions resulted in significantly higher adsorption of NO₃⁻ that was up to about 80% in cycles #4 and #5 (FIG. 12). The maximal adsorption density for nitrate on CFFCs obtained in this study was 0.175 meq/g, which corresponds to the salt adsorption capacity (SAC) of about 10 mgNaCl/g_carbon. Significantly higher adsorption densities of nitrate achieved in pH-controlled experiments conducted with Pt—Cu CFFCs can be attributed to a higher equilibrium potential of oxygen reduction reaction at lower pHs.

As shown in FIG. 12, every H₂-induced step of NO₃⁻ desorption/hydrogenation resulted in fast increase of nitrate concentration in regeneration solution of up to about 130 mgNO₃⁻/l. The sharp increase in nitrate concentration was followed by the very fast disappearance of nitrate due to the hydrogenation process (Eq. 3 and Eq. 4). In all five experimental cycles practically all separated nitrate ions were reduced into N₂ and ammonia within less than 6.5 hours that corresponds to reduction rate of about 38 mgNO₃⁻/l/h/gPt. This rate of hydrogenation is approximately 30 times higher than NO₃⁻ reduction rate obtained for CFFCs that were loaded with Pt catalyst only.

The selectivity of the hydrogenation process to ammonia was 46, 42 and 43% in the last three cycles. Obviously, the obtained N₂-selectivity of the hydrogenation indicates that the catalyst structure requires further optimization. The concentration of nitrite in all experiments was lower than the detection limit of the applied ion-chromatography technique.

### CONCLUSIONS

This process, according to some embodiments of the present invention, drown to separation and catalytic hydrogenation of nitrate ions from water has been demonstrated. The process utilizes micro-scale capacitive-faradaic fuel cells (CFFC) that comprise activated carbon particles loaded with Pt—Cu catalyst capable of (i) oxygen reduction reaction, (ii) hydrogen oxidation reaction, and (iii) nitrate hydrogenation. The process comprises two subsequent steps. First the treated water is saturated with oxygen that results in faradaic oxygen reduction reaction on the faradaic electrode (i.e., Pt) of the micro-scale fuel cell. This reaction leads to electrons' deficiency in the capacitive electrode (e.g., activated carbon) of the cell. To achieve electroneutrality the nitrate ions are adsorbed into the electric double layer of the carbon electrode. The second step aimed at regeneration of CFFC is initiated by the H₂ gas that is oxidized on Pt electrode that leads to repulsion of nitrate ions from the activated carbon electrode into the regeneration solution. In parallel to nitrate repulsion the NO₃⁻ ions are reduced by hydrogen into N₂ and NH₄⁺ on Pt—Cu catalysts of the CFFC.

The concept of the process, according to some embodiments of the present invention, was proved using the batch-mode experiments and NaNO₃ solutions in deionized water. The CFFCs made of mesoporous carbon Lewatit AF5 loaded with Pt and Pt—Cu catalysts were applied. Application of Pt metal alone resulted in reasonable separation and desorption rates of NO₃⁻ ions but the hydrogenation rate was very low. Introduction of Cu catalyst into the CFFC structure resulted in about 30 times higher hydrogenation rate. The O₂-induced adsorption of nitrate was much more efficient in experiments with pH-control at slightly acidic pH of 5.5 than in experiments performed without a pH control (that resulted to an increase in pH to 7.2-8.2 due to the oxygen reduction reaction).

### Example 3

### Macro-Scale CFFCs

The main objectives of this Example are (i) to explain and verify experimentally the polarization mechanism of the CFFC, (ii) to explore the effect of faradaic and activated carbon electrodes composition on CFFC polarization, (iii) to introduce the concept of divided and undivided macro-scale CFFCs as an effective tool to investigate the CFFC technology and to separate ions, and (v) to convert chemical energy of H₂ and O₂ into the electrical energy (energy conversion and storage).

FIGS. 13A-B present the structure and principle of macro-scale capacitive-faradaic fuel cells, wherein FIG. 13A shows macro-scale CFFC with two fixed electrodes, and FIG. 13B shows macro-scale CFFC with one fixed and one flowing electrode.

As can be seen in FIGS. 13A-B, the structure of the macro-scale capacitive-faradaic fuel cells is an exemplary fixed-electrode CFFCs design, schematically shown in FIG. 13A. In this cell a stagnant capacitive electrode made of activated carbon fibers is pressed to a fixed faradaic electrode. The ORR (Eq. 1) on the faradaic cathode results in depletion of electrons in the capacitive AC-made anode (FIG. 13A). To maintain the electro-neutrality anions are adsorbed into the electrical double layer of AC fibers.

To separate anions into a concentrate stream a separate portion of H₂-saturated water is recirculated through the reactor (not shown in FIGS. 13A-B). The HOR on the faradaic electrode results in accumulation of electrons in the capacitive AC electrode and repulsion of anions into the concentrate solution. For cations separation the O₂—H₂ sequence must be reversed. The same principle is applied in the macro-scale flow-electrode CFFC which is schematically shown in FIG. 13B. In this cell the stagnant faradaic electrode is combined with a flow-electrode which is a dispersion of activated carbon particles in water.

As can be seen in FIG. 13B, the separation of cations is induced by the HOR on the Pt electrode. Carbon particles become polarized each time they collide with the Pt electrode (or other polarized particles) and accumulate electrons produced in HOR. The electroneutrality in every AC particle is achieved by electrosorption of cations. To separate anions the O₂ step should be followed by the H₂-step.

The capacitive and faradaic electrodes in the cells shown in FIGS. 13A-B can be separated by the ion exchange membrane or porous diaphragm. This separation will make it possible to monitor a cell current and to determine the variation of electrodes' potentials during the CFFC operation. In addition, the divided macro-scale CFFC can be considered as novel type of fuel cells for electrical energy production in which the O₂ (or another oxidant) reduction and the H₂ (or another fuel) oxidation steps are decoupled.

### Mixed Potentials of Activated Carbon and Pt-Based Electrodes:

The open circuit potentials (OCPs) of (i) platinum wire, (ii) Ti/Pt—IrO₂, (iii) activated carbon (AC) powder, and (iv) AC fleece electrodes were measured versus Ag/AgCl reference electrode (3 M KCl, Metrohm) in aerated and hydrogenated NaCl solutions at varied pHs. For preparation of Ti/Pt—IrO₂ electrode a titanium fleece (0.9 mm thickness, 70% porosity, 20 μm fiber diameter, Bekaert) was coated with Pt/IrO₂ catalysts (about 2.25 mg_{catalyst}/cm², Pt/Ir weight ration=30/70) by thermal decomposition of H₂PtCl₆ and H₂IrCl₆ precursors. The AC powder electrode was formulated by casting an AC paste on a graphite foil current collector followed by drying in a vacuum oven. The paste comprised 85% (wt.) Norit SX Ultra Activated Charcoal (Sigma-Aldrich), 10% (wt.) PVDF binder and 5.0% (wt.) of carbon black homogenised in NMP solvent. The AC felt electrode was made of 2 mm thick Carbopon-B-active (BET surface area—964 m²/g, OJSC Svelogotsk Khimvolokno, Belarus). In every experiment 100 mL of HCl (0.1 M) solution was titrated with NaOH (1M) at 0.4 mL/min flowrate. The pH was recorded by 914 EC/pH meter equipped with 6.0228.000 glass electrode (Metrohm). The open circuit potential in each experiment was monitored using the PGSTAT302N potentiostat/galvanostat (Autolab).

Divided Macro-Scale CFFC with Fixed Electrodes:

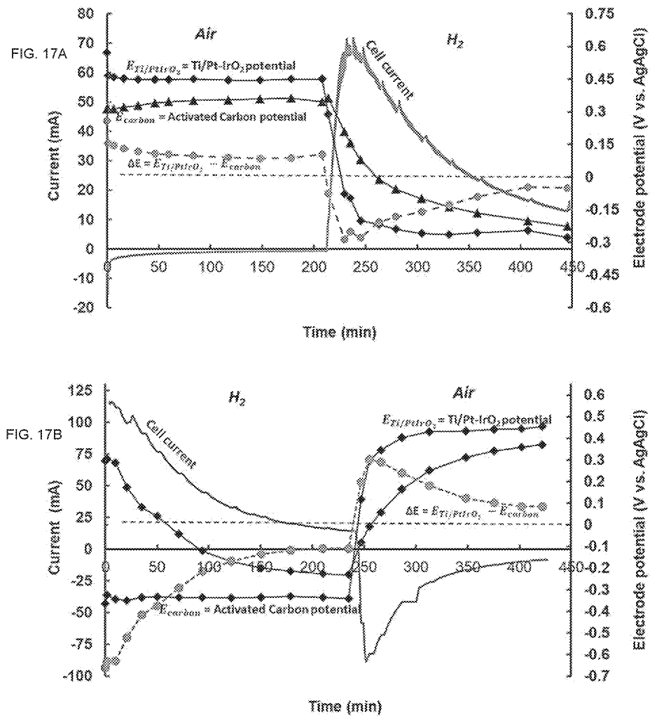

The divided cell comprised Carbopon-B-active (two layers) electrode (weight—4.62 g, size—11·11 cm·cm) and Ti/Pt—IrO₂ fleece electrode (11·11 cm·cm) that were separated by a Nafion 117 membrane (active area—11·11 cm·cm). The electrodes and the membrane between them were installed into a cell equipped with two epoxy-impregnated graphite current collectors engraved with flow-fields (200 cm long, 3 mm deep and 3 mm wide) for a recirculation (125 mL/min) of NaCl electrolyte solution (500 ml, [NaCl]₀=50 mg/L) between the cell and a holding vessel that was purged with air or H₂ gas (200 mL/min). Within the first set of experiments the cell was operated with air and next with the hydrogen gas. Within the second set of experiments this sequence was reversed. In every experiment the cell was short-circuited and electric current was recorded continuously using the PGSTAT302N potentiostat/galvanostat. The OCPs of both electrodes were measured periodically versus the Ag/AgCl (3 M KCl) reference electrodes that were installed in the system using the Luggin capillaries. The electrode potential of carbon electrode was brought to 0.313 V (the OCP of uncharged activated carbon electrode, see FIG. 16 below) electrolytically to discharge its electric double layer after the first set of experiments.

Undivided Macro-Scale CFFC with Fixed Electrodes:

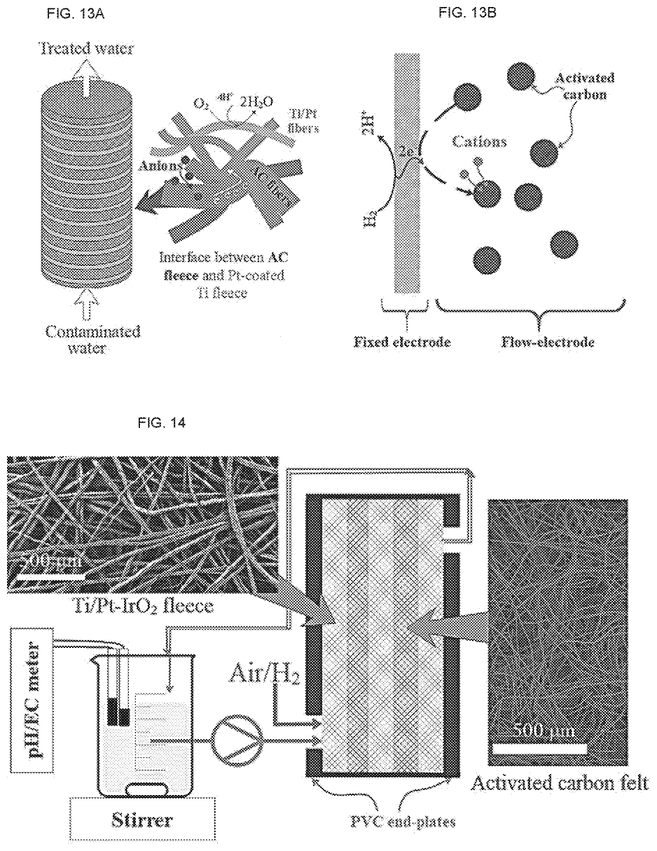

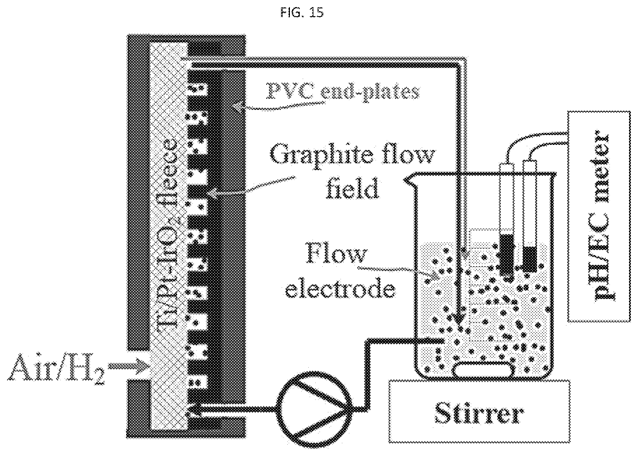

FIG. 14 presents a schematic illustration of the structure of a macro-scale CFFC with fixed electrodes, according to some embodiments of the present invention.

As can be seen in FIG. 14, the CFFC comprised two 2 mm thick rectangular (11·11 cm·cm) AC felt electrodes (4.47 g overall) compressed between three Ti/Pt/IrO₂ electrodes. The NaCl solution (500 ml, [NaCl]₀=50 mg/L) was recirculated through the CFFC at a constant flow rate of 100 mL/min. Compressed air and H2(g) (150-200 mL/min) were injected into the water stream at the inlet of the CFFC. Periodically 2-mL samples were withdrawn from the system and analysed using the Metrohm 930 compact IC flex.

Undivided Macro-Scale CFFC with Fixed Faradaic Electrode and Flowing Capacitive Electrode:

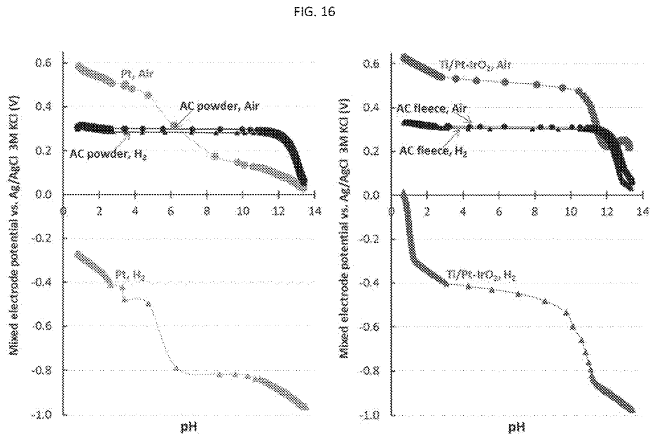

FIG. 15 presents a schematic illustration of a macro-CFFC structure, according to some embodiments of the present invention, with one fixed and one flowing electrode, showing the experimental system and the structure of the macro-scale CFFC with Ti/Pt—IrO₂ faradaic electrode and the flowing capacitive electrode which was a dispersion (500 mL) of AC particles (5 wt. %, Norit SX Ultra) in NaCl, NH₄SO₄ or NaNO₃ solutions.

As can be seen in FIG. 15, the CFFC cell comprised one Ti/Pt—IrO₂ fleece (11·11 cm·cm) pressed to an epoxy-impregnated graphite plate engraved with a flow-field (200 cm long, 3 mm deep and 3 mm wide). The flow electrode was recirculated between the glass beaker and the CFFC by a peristaltic pump at 100 mL/min flow rate. Periodically 2-mL samples of the flow electrode were withdrawn from the system, filtered via the 0.22 μm syringe filter and analysed for ionic composition. Aqueous solution was separated from AC particles by filtration at the end of each cycle.

### Mixed Potentials of Activated Carbon and Pt-Based Electrodes:

FIG. 16 presents the results of the process, according to some embodiments of the present invention, as conducted with the mixed electrode potentials (vs. Ag/AgCl, 3 M KCl reference electrode) of Pt, Ti/Pt—IrO₂ fleece, activated carbon powder, and activated carbon fleece electrodes in NaCl solutions aerated and hydrogenated at varied pHs, whereas shown are the open circuit potentials (OCPs) obtained on Pt, Ti/Pt—IrO₂, AC powder, and AC fleece electrodes in NaCl solution at varied pH levels.

As can be seen in FIG. 16, the OCPs of both ACs were almost constant at about 300 mV in 0.9<pH<10.5 range in hydrogenated and oxygenated solutions. At pH>10.5 the OCPs of AC electrodes decreased and reached about 50 mV at pH=13.3. The OCP of Pt in aerated solution decreased gradually from 584 mV at pH=0.9 to 30 mV at pH=13.3. As can further be seen in FIG. 16, the mixed potentials of ACs are higher than the OCP of Pt in aerated NaCl solution at pH>6.5. This means that according to the herein proposed mechanism, the macro-scale CFFC that comprises Pt and AC electrodes is unsuitable for Cl⁻ removal from NaCl solution at pH>6.5. The OCP of Ti/Pt—IrO₂ electrode in aerated solution gradually decreases from 618 mV at pH=0.9 to 475 mV at pH=10.44. In all this range the CFFC comprising Ti/Pt—IrO₂ and AC electrodes used in this study is expected to be suitable for O₂-induced removal of Cl⁻ anions from NaCl solutions.

In hydrogenated NaCl solution the OCPs of both Pt and Ti/Pt—IrO₂ electrodes are significantly lower than the OCPs of activated carbons. Within the pH 2.5-10.5 pH range the difference in mixed potentials of metallic and AC electrodes in hydrogenated NaCl solution was up to 1000 mV. Consequently, the CFFC process is expected to be very fast and effective for cations separation from NaCl solution and for the regeneration of anions-loaded CFFCs.

Divided Macro-Scale CFFC with Fixed Electrodes:

FIGS. 17A-B present the results of operations of the divided macro-scale CFFC with fixed electrodes, showing the cell current and electrode potentials in divided macro-scale CFFCs with fixed electrodes, whereas FIG. 17A shows an air-induced operation followed by H₂-induced step, and FIG. 17B shows H₂-induced operation followed by Air-induced step.

As can be seen in FIG. 17A, the aeration of NaCl solution resulted in negative spontaneous current (i.e., electrical energy was generated) that increased from −15 mA to −0.74 mA within 212 minutes. In parallel the open circuit electrode potentials of Ti/Pt—IrO₂ and activated carbon fleece decreased from 572 mV to 450 mV and increased from 313 mV to 360 mV, respectively. The difference in mixed electrode potentials decreased from 258 mV to 104 mV during the air-induced operation. Once the air bubbling was replaced with hydrogen, the direction of electrical current was immediately reversed (i.e., more electrical energy was generated), and the maximal spontaneous current of 68 mA was achieved after 250 minutes of the experiment. At this point a maximal difference between the mixed electrode potentials of 278 mV was obtained. The H₂-induced current decreased with time in parallel to the decrease in the difference between the mixed electrode potentials and became 13 mA and 50 mV (respectively) after 445 minutes.

As can be seen in FIG. 17B, the same trends in electrode potentials and electric currents appears in the results of CFFC operated first with hydrogen gas and next with the air. The relatively low current obtained in first air-induced operation (FIG. 17A) and high H₂-induced currents (FIGS. 17A-B) are explained by small and large (respectively) differences of open circuit electrode potentials of Ti/Pt—IrO₂ and activated carbon electrodes, as shown in FIG. 16 and FIGS. 17 A-B. Another possible factor is a relatively high overpotential of the oxygen reduction reaction compared to the hydrogen oxidation reaction on the Ti/Pt—IrO₂ electrode.

The behaviour of open circuit potentials, directions and magnitudes of electric currents obtained in divided CFFC (FIGS. 17A-B) agree with the capacitive-faradaic mechanism proposed herein for the micro-scale CFFCs. In should be mentioned that the divided macro-scale CFFC has much higher ohmic resistance between the electrodes than undivided macro-scale and micro-scale CFFCs. In spite this fact the divided cell is an effective tool to understand the mechanisms involved in the CFFC processes and to develop further the technology.

Moreover, the results shown in FIGS. 17A-B show that the divided CFFCs disclosed in this invention can be used for conversion of chemical energy of a reductant (fuel; e.g., H₂) and an oxidant (e.g., O₂) into the electrical energy. In contrast to the common fuel cells, the process, according to some embodiments of the present invention, utilizes two steps for energy conversion and storage. The device should be first powered by a reductant (fuel) and afterwards by an oxidant, or vice versa.

Undivided Macro-Scale CFFC with Fixed Electrodes:

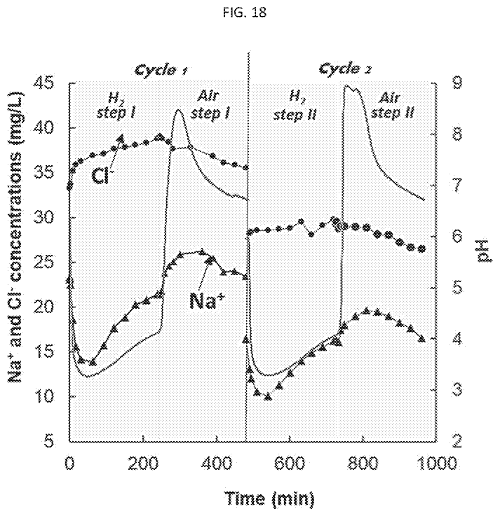

FIG. 18 presents the results of two consequent H₂-Air cycles conducted on NaCl solutions in the batch mode macro-scale CFFC that comprised two fixed electrodes. [NaCl]₀=50 mg/L, 500 mL; activated carbon load—4.47 g, showing that oxygenation and hydrogenation of NaCl solution resulted in significant pH fluctuations between about 3.26 and about 8.5 due to ORR and HOR on Pt.

As can be seen in FIG. 18, in a blank experiment conducted with AC felt but without Ti/Pt—IrO₂ fleece the pH of NaCl solution remained constant (i.e., pH=10.36±0.06) during repeating aeration-hydrogenation cycles. Introduction of H₂ gas forced the pH to decrease from 6.41 to 3.26 after 44 minutes (FIG. 18, H₂ step I). This decrease in the pH was accompanied by a decrease in concentration of Na⁺ cations and small increase in the concentration of Cl⁻ anions.

An increase in [Cl⁻] above its initial value is due to the chloride ions originally present in the AC felt. After the initial decrease, the Na⁺ concentration started to increase, as well as the pH that raised from pH3.26 (at 44 min) to pH4.06 (at 246 min). The exact reasons for the release of Na⁺ cations and the pH behaviour observed within the H₂-step can be attributed to the exchange of Na⁺ cations on the carbon surface with H⁺ ions generated by the HOR (Eq. 2). This statement is supported by the results obtained in operation of the divided CFFC cell (FIG. 17B). The overall charge (620 C) conducted in the divided CFFC during the H₂-induced step was expected to result in removal of about 150 mgNa/L of sodium (i.e., complete removal of sodium ions) in the treated solution. However, in the experiment shown in FIG. 18 much smaller amounts of Na⁺ were removed. It can be concluded that the electroneutrality of the activated carbon was achieved mostly by the electrosorption of H⁺ ions. Consequently, operation of the CFFC process with pH-buffered solutions is expected to result in better separation of cations.

Aeration of NaCl solution resulted in ORR (Eq. 1) which led to a sharp increase in the pH from 4.06 to 8.48 after 200 minutes of the experiment (FIG. 18, Air step I). The ORR resulted in adsorption of chloride ions and further release of Nations from the carbon. The [Na⁺] reached maximum of about 26 mgNa/L after 360 minutes of the experiment that is higher than the initial concentration of sodium (i.e., 19.7 mgNa/L). Apparently, the AC contained some amounts of NaCl that could not be removed by washing with deionized water used in this study. This fact makes a calculation of salt adsorption capacity for NaCl in the tested system unreliable. After the maximum, the concentration of sodium decreased to 23.5 mg/L. The reason for this phenomenon (that was also observed within the second H₂-Air cycle) is unclear.

As can be seen in FIG. 18 the aeration of NaCl solution resulted in sharp pH increase that was followed by the pH reduction. This decrease in the pH is apparently due to adsorption of OH⁻ ions by the AC and CO₂ adsorption from air. Similar behaviour of [Na⁺], [Cl⁻] and pH was observed within the second H₂-Air cycle started with a new portion of NaCl solution. The maximal values of ion adsorption capacity for Na⁺ and Cl⁻ ions (measured in second operation) were 2.16 mgNa⁺/g and 0.85 mgCl⁻/g. These SAC values are significantly lower than in conventional CDI processes with reported SAC value of 3.7-13.5 mgNaCl/g.

Macro-Scale CFFC with Fixed Faradaic Electrode and Flowing Capacitive Electrode:

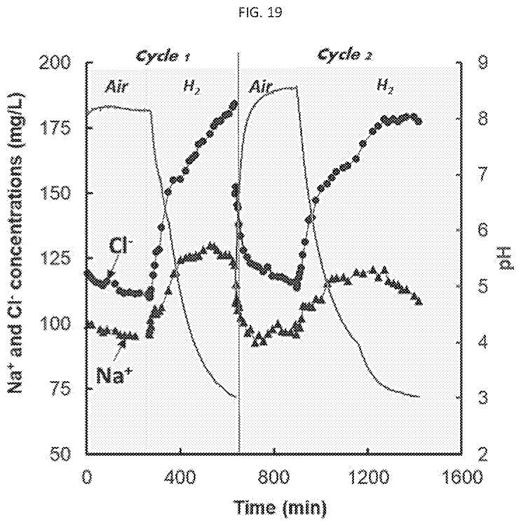

FIG. 19 presents the results of two Air-H₂ cycles conducted with NaCl solutions in the macro-scale CFFC system comprising fixed Ti/Pt—IrO₂ and activated carbon flowing electrodes. [NaCl]₀=234 mg/L, 500 mL; activated carbon load—25 g.

The pH behaviour observed in Air and H₂ steps agrees with reactions Eq. 1 and Eq. 2. A separate experiment of oxygenation and hydrogenation of AC slurry in a system without Ti/PtIrO₂ electrode resulted in insignificant pH change (pH=8.02±0.044) as no ORR and HOR could proceed without the Pt catalyst. Aeration of the electrodes (Cycle 1 in FIG. 19) resulted in minor adsorption of Na⁺ and Cl⁻ ions accompanied by a slight increase of the pH. During the hydrogen step (cycle #1) the concentrations of both Na⁺ and Cl⁻ increased above their initial concentrations due to the NaCl initially present in AC particles. The pH in H₂ step decreased fast from 8.11 to 3.03 due to the HOR (Eq. 2). The aeration step of the second cycle resulted in sharp increase of the pH from 4.95 to 8.54. Both [Na⁺] and [Cl⁻] decreased during the Air-step of cycle #2 and increased within the hydrogenation step (FIG. 19). The observed behaviour of [Cl⁻] agrees and the [Na⁺] behaviour contradicts the mechanism proposed herein for the micro-scale CFFCs. For instance, oxygenation was expected to result in release of Na⁺ cations and hydrogenation in adsorption of Na⁺ ions. This phenomenon can be explained by attraction and detraction of Na⁺ cations by the charged surface groups (e.g., carboxylic) on the carbon surface. For instance, the pH increase obtained within the ORR makes the carbon surface more negative that can result in adsorption of sodium ions. On the other hand, the acidification of solution by the HOR is expected to result in more positive carbon surface and a release of cations.

To verify that the obtained trends are not specific for Na⁺ and Cl⁻ ions the experiment was repeated with ammonium sulphate solution at an initial concentration of 529 mg/L (4 mM).

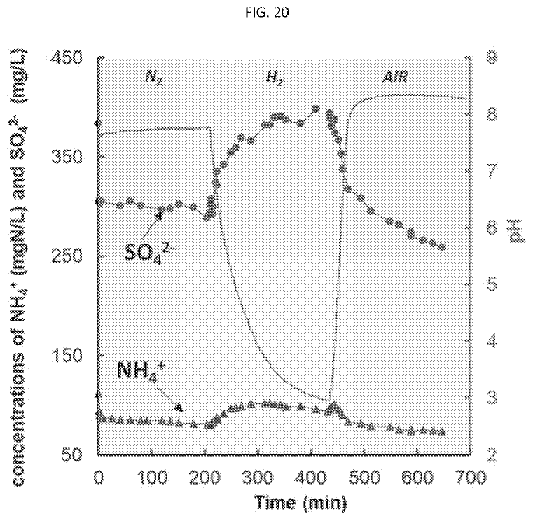

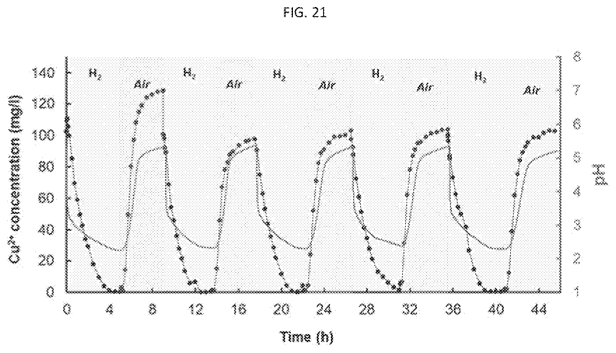

FIG. 20 presents the results obtained during the CFFC process operated on (NH₄)₂SO₄ solution within three consecutive steps conducted with nitrogen gas, hydrogen gas and air, using a macro-scale CFFC system, according to some embodiments of the present invention, that comprised fixed Ti/Pt—IrO₂ faradaic electrode and activated carbon flowing capacitive electrode [(NH₄)₂SO₄]₀=529 mg/L, 500 mL; activated carbon load—25 g].

As can be seen in FIG. 20, the trends in adsorption and desorption of NH₄⁺ cations and SO₄²⁻ anions are similar to those obtained for Na⁺ and Cl⁻ ions. Spontaneous adsorption of NH₄⁺ and SO₄²⁻ in N₂ step was followed by a release of both ions when the gas flow was switched to H_{2(g)}. Aeration resulted in adsorption of both ions. Similarly to the macro-scale CFFC with two fixed electrodes the behaviour of anions was in agreement with the capacitive-faradaic mechanism proposed herein for CFFC. However, the behaviour of cations contradicts it. As it has been already mentioned, the cations' behaviour is apparently due to the pH-influenced adsorption and desorption of cations by the functional groups of the carbon surface. The maximal ion adsorption capacity values for Na⁺, Cl⁻, NH₄⁺, and SO₄²⁻ ions were 0.64, 1.4, 0.9 and 5.4 mg/g carbon, respectively.

### CONCLUSIONS

In this example the mixed potentials of faradaic (Pt and Ti/Pt—IrO₂) and capacitive (activated carbon powder and fleece) electrodes were measured in aerated and hydrogenated NaCl solutions at varied pHs to explain and demonstrate the polarization mechanism of capacitive-faradaic fuel cells. Afterwards two configurations of divided and undivided macro-scale CFFCs were proposed and demonstrated. The first system comprised two fixed electrodes made of Ti/Pt—IrO₂ and activated carbon fleeces. In the second system the AC fleece was replaced with the flowing capacitive electrode (i.e. suspension of AC particles). In both systems the adsorption-desorption behaviour of anions and the pH were in agreement with the proposed capacitive-faradaic mechanism, but the behaviour of cations contradicts it.

Therefore, it can be concluded that additional mechanisms (e.g., faradaic processes involving electrochemically active surface groups, and adsorption-desorption of H⁺ and OH⁻ ions) are involved in CFFC. The behaviour of electric currents and open circuit potentials observed in H₂ and O₂-induced operations of the divided macro-scale CFFC agreed with the proposed capacitive-faradaic mechanism of the CFFC and revealed that the O₂-induced operation is much slower that the H₂-induced process.

Activated carbons with relatively low open circuit potentials (e.g., about 0 V vs. Ag/AgCl) in treated solution are also expected to be effective for O₂-induced separation of anions than carbons used in this study (OCP of about 300 mV). According to the results obtained in operations of divided and undivided CFFCs it can be concluded that separation of cations is hampered by competitive adsorption of H⁺ ions and introduction of pH-buffering capacity might be required.

### Example 4

### Copper Ions Removal

FIG. 21 presents the results of five batch-mode experiments conducted using the system shown in FIG. 4 on 1 liter solutions of CuCl₂ in deionized water and CFFCs (7.5 g) that comprised granular activated charcoal (CH104, mesh size 12-20, Spectrum) loaded with 0.5% (wt.) of platinum catalyst, whereas in each cycle the CuCl₂ solution (1 liter, [Cu²⁺]₀=100 mg/l) was first hydrogenated for 4.5 hours and afterward aerated for another 4 hours.

As can be seen in FIG. 21, the final Cu²⁺ concentration obtained after each H₂-induced operation was below the detection limit of the analytical technique applied in this example (and lower than the maximal concentration in drinking water of 2 mg/l as recommended by World Health Organization).

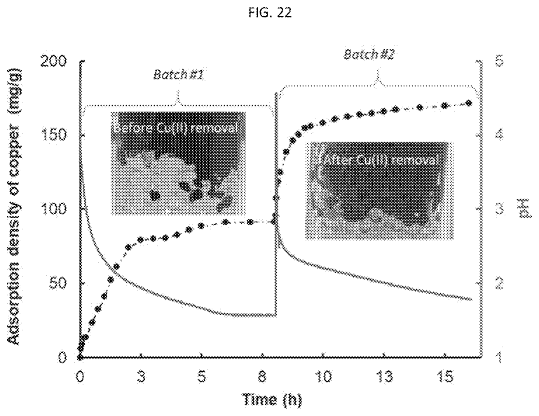

FIG. 22 presents the result of two subsequent H₂-induced Cu²⁺ adsorptions by the CFFCs in the system shown in FIG. 4, wherein 7.5 grams of CFFCs with 2.5% Pt loading and 1 liter of CuCl₂ solution in deionized water (initial Cu²⁺ concentration of 600 mg/l) were used, and the final concentrations of Cu²⁺ ions was 0.24 mg/l and 80.35 mg/l at the end of the first and the second adsorption cycles, that corresponds to adsorption capacities of 91 mgCu/g and 171 mgCu/g, respectively. The value of 171 mgCu/g corresponds to the charge density (Q) of about 520 C/g. Assuming a validity of Q=C·ΔV (where C and ΔV are capacitance and electrode polarization potential, respectively) relation for the CFFCs, at carbon polarization of up to 640 mV at pH about 2 (see, FIG. 15) and charge density (Q) of 520 C/g the specific capacitance of granular activated charcoal should be at least 812 F/g. This value is higher than the typical values of 30-320 F/g reported for activated carbons with specific surface area within a 378-1270 m²/g range.

Consequently, the results shown in FIG. 22 provide a strong indication that another mechanism governs copper ions removal by the CFFCs, in addition to electro sorption of Cu²⁺ ions by the activated carbon.

Standard reduction potential (Eᵣ⁰) of Cu²⁺ (Eq. 3) is +0.34 V (vs. SHE). Consequently, the Cu²⁺ ions can be reduced by hydrogen gas as described by Eq. 7.

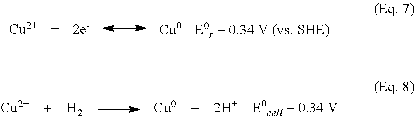

The Eᵣ⁰ of hydrogen increases at higher pH and the Eᵣ⁰ of copper is independent of the pH value. Reduction of Cu²⁺ ions by H₂ gas at 1 atm pressure is thermodynamically favourable at any positive pH (Agrawal et al., 2006). Nevertheless, hydrogenation of copper ions requires high temperatures of 135-200° C. to proceed at sufficient rates (Park et al., 2015).

The results presented in FIG. 22 suggest that Cu²⁺ removal by the CFFCs can proceed via reduction by H₂ catalyzed by the Pt metal in addition to electrosorption of Cu²⁺ ions by activated carbon.

Apparently, the oxidation reaction of elemental copper by air oxygen (Eq. 9) in the CFFC process is also catalyzed by the Pt catalyst. However, non-catalyzed oxidation of Cu nanoparticles by the oxygen was also reported (Pacioni et al., 2013).

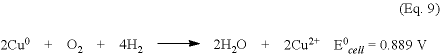

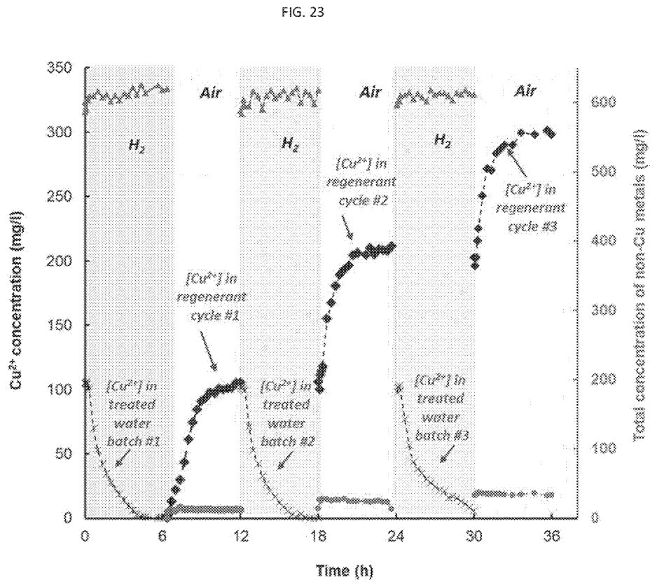

FIG. 23 presents results of Cu²⁺ ions separation in the system shown in FIG. 4 by the 0.5% Pt—CFFCs from a mixture of Cu²⁺, Ni²⁺, Cd²⁺, Fe³⁺, Ca²⁺, Mg²⁺ and Zn²⁺ ions, wherein the total concentration of non-Cu metals remained practically unchanged in the treated water and only minor amounts of non-Cu metals have been accumulated in the regeneration solution.

As can be seen in FIG. 23, the total concentration of six non-Cu metals in the regeneration solution after three cycles was as low as 34 mg/l, which is only 0.315% of the overall amount of non-Cu metals that were present in three batches of water treated by the CFFCs system. The Cu²⁺ ions were completely removed from all three batches of water (FIG. 23). Within the air-induced regeneration steps all copper ions were released into the regeneration solution that accumulated about 300 mgCu/l after the third regeneration cycle.

It can be concluded that the CFFC process, according to some embodiments of the present invention, is highly selective for the separation of Cu²⁺ ions.

### Example 5

### Separation and Hydrogenation of Perchlorate Ions

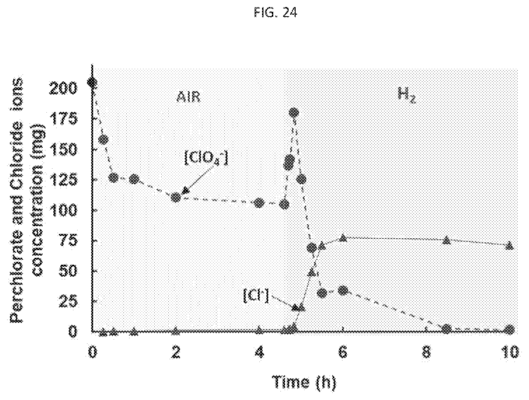

FIG. 24 presents the results of perchlorate ions separation and their hydrogenation in the batch mode system similar to the one shown in FIG. 4, using the CFFCs that comprised 7.5 grams of granular activated carbon loaded with 5 wt. % of Pt catalyst. The NaClO₄ solution (500 mL, initial [ClO₄⁻]=200 mg/L) comprised also an ammonium perrhenate (NH₄ReO₄) catalyst (initial perrhenate concentration of 100 mg ReO₄/L).

First the solution was aerated in the system for 4.6 hours and thereafter hydrogenated for another 5.4 hours.

As can be seen in FIG. 24, aeration resulted in adsorption of perchlorate anions by the CFFCs. The hydrogenation resulted in complete hydrogenation of perchlorate ions into the chloride ions in accordance with Eq. 10:

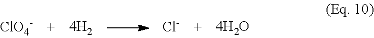

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

In addition, any priority document(s) of this application is/are hereby incorporated herein by reference in its/their entirety.

### REFERENCES

[1] Matilainen, A., Vieno, N., Tuhkanen, T., 2006. Efficiency of the activated carbon filtration in the natural organic matter removal. Environment International. 32(3), 324-331.
[2] Urano, K., Yamamoto, E., Tonegawa, M., Fujie, K., 1991. Adsorption of chlorinated compounds on activated carbon from water. Water Research. 25(12), 1459-1464.
[3] Mansour, F., Al-Hindi, M., Yahfoufi, R., Ayoub, G. M., 2018. The use of activated carbon for the removal of pharmaceuticals from aqueous solutions: a review. Reviews in Environmental Science and Bio/Technology. 17, 109-145.
[4] Meng, F., Li, G., Zhang, B., Guo, J., 2018. Chemical kinetics and particle size effects of activated carbon for free chlorine removal from drinking water. Water Practice & Technology. 14(1), 19-26.
[5] Mahmudov, R., Huang, C. P., 2010. Perchlorate removal by activated carbon adsorption. Separation and Purification Technology. 70(3) 329-337.
[6] Habuda-Stanic, M., Ravancic, M. E., Flanagan, A., 2014. A Review on adsorption of fluoride from aqueous solutions. Materials. 7, 6317-6366.
[7] Bhatnagar, A., Sillanpaa, M., 2011. A review of emerging adsorbents for nitrate removal from water. Chemical Engineering Journal. 168(2), 493-504.
[8] Mondal, M. K., Garg, R., 2017. A comprehensive review on removal of arsenic using activated carbon prepared from easily available waste materials. Environmental Science and Pollution Research. (24), 1325-13306.
[9] Karnib, M., Kabbani, A., Holail, H., Olama, A., 2014. Heavy metals removal using activated carbon, silica and silica activated carbon composite. Energy Procedia. 50, 113-120.
[10] Gonce, N., Voudrias, E. A., 1994. Removal of chlorite and chlorate ions from water using granular activated carbon. Water Research. 28(5), 1059-1069.
[11] Li, L. Y., Gong, X, Abida, O., 2019. Waste-to-resources: Exploratory surface modification of sludge-based activated carbon by nitric acid for heavy metal removal. Waste Management. 87(15), 375-386.
[12] Ge, Y., Li, Z., Xiao, D., Xiong, P., Ye, N., 2014. Sulfonated multi-walled carbon nanotubes for the removal of copper (II) from aqueous solutions. Journal of Industrial and Engineering Chemistry. 20(4), 1765-1771.
[13] Palko, J. W., Oyarzun, D. I., Ha, B., Stadermann, M., Santiago, J. G., 2018. Nitrate removal from water using electrostatic regeneration of functionalized adsorbent. Chemical Engineering Journal. 334(15), 1289-1296.
[14] Porada, S., Zhao, R., van deer Wal, A., Presser, V., Biesheuvel, P. M., 2013. Review on the science and technology of water desalination by capacitive deionization. Progress in Materials Science. 58(8), 1388-1442.
[15] Hassanvand, A., Wei, K., Talebi, S., Chen, G., Q., Kentish, S. E., 2017. The role of ion exchange membranes in membrane capacitive deionization. Membranes. 7(3), 54.
[16] Jeon, S., Park, H., Yeo, J., Yang, S. C., Cho, C. H., Han, M. H., Kim, D. K. 2013. Desalination via a new membrane capacitive deionization process utilizing flow-electrodes. Energy & Environmental Science. 6(5), 1471-1475.
[17] Kim, T., Gorski, C. A., Logan, B. E., 2017. Low energy desalination using battery electrode deionization. Environmental Science & Technology Letters. 4(10), 444-449.
[18] Zhang, X., Zuo, K., Zhang, X., Zhang, C., Liang, P., 2019. Selective ion separation by capacitive deionization (CDI) based technologies: a state-of-the-art. Environmental Science Water Research & Technology. doi: 10.1039/C9EW00835G.
[19] Atlas, I., Suss, M. E., 2019. Theory of simultaneous desalination and electricity generation via an electrodialysis cell driven by spontaneous redox reactions. Electrochimica Acta. 319, 813-821.
[20] Martinez, J., Ortiz, A., Ortiz, I., 2017. State-of-the-art and perspectives of the catalytic and electrocatalytic reduction of aqueous nitrates. Applied Catalysis B: Environmental. 207, 42-59.
[21] Shukla, A. Pande, J. V., Bansiwal, A., Osiceanu, P., Biniwale, R. B., Catalytic Hydrogenation of Aqueous Phase Nitrate over Fe/C Catalysts, Catal. Letters. 131(2009) 451-457. doi: 10.1007/s10562-009-9899-9.
[22] Hurley, K. D., Shapley, J. R., 2007. Efficient heterogeneous catalytic reduction of perchlorate in water. Environmental Science & Technology. 41(6), 2044-2049.
[23] Chen, H., Xu, Z., Wan, H., Zheng, J., Yin, D., Zheng, S., 2010. Aqueous bromate reduction by catalytic hydrogenation over Pd/Al₂O₃ catalysts. Applied Catalysis B: Environmental. 96(3-4), 307-313.
[24] Mehrabadi, B. A. T., Eskandari, S., Khan, U., White, R. D., Regalbuto, J. R., 2017. Chapter One—A review of preparation methods for supported metal catalysts. Advances in Catalysis. 61, 1-35
[25] Gewirth, A. A., Varnell, J. A., DiAscro, A. M., 2018. Nonprecious metal catalysts for oxygen reduction in heterogeneous aqueous systems. Chemical Reviews. 118(5), 2313-2339.
[26] Chen, Z., Dodelet, J-P., Dodelet, J. Z., 2014. Non-noble metal fuel cell catalysts. Wiley-VCH Verlag GmbH & Co. KGaA, DOI: 10.1002/9783527664900
[27] Yu, F., Wang, L., Wang, Y. Shen, X., Cheng, Y., Ma, J., 2019. Faradaic reactions in capacitive deionization and ion separation. Journal of Materials Chemistry A. 7, 15999-16027.
[28] Suss, M. E., Presser, V., 2018. Water desalination with energy storage electrode materials. Joule. 2(1), 10-15.
[29] Mangun, C. L., Benak, K. R., Daley, M. A., Economy, J., 1999. Oxidation of activated carbon fibers: effect on pore size, surface chemistry, and adsorption properties. Chemistry of Materials. 11, 3476-3483.
[30] Carabineiro, S. A. C., Pereira M. F. R., Orfao, J. J. M., Figueiredo, J. L., 2011. Surface chemistry of activated carbons. Chemical Physics Research Journal. 4(3/4), 291-333.
[31] Kang, S., Ye, J., Chang, J., 2013. Recent Advances in carbon-based sulfonated catalyst: preparation and application. International Review of Chemical Engineering. 5(2), 133-144.
[32] Moreno-Castilla. C., Ferro-Garcia, M. A., Joly, J. P., Bautista-Toledo, I., Carrasco-Marin. F., Rivera-Utrilla, J., 1995. Activated carbon surface modifications by nitric acid, hydrogen peroxide, and ammonium peroxydisulfate treatments. Langmuir. 11, 4386-4392.
[33] Sud, D., 2012. Chelating ion exchangers: theory and applications, In: Ion exchange technology I. Springer Netherlands.
[34] Houshmand, A., Wan Daud, W. M. A., Shafeeyan, M. S., 2011. Exploring potential methods for anchoring amine groups on the surface of activated carbon for CO₂ adsorption. Separation Science and Technology. 46, 1098-1112.
[35] Mahmudov, R., Shu, Y., Rykov, S., Chen, J., Huang, C. P., 2008. The reduction of perchlorate by hydrogenation catalysts. Applied Catalysis B: Environmental. 81(1-2), 78-87.
[36] A. Agrawal, V. Kumar, B. D. Pandey, K. K. Sahu, A comprehensive review on the hydro metallurgical process for the production of nickel and copper powders by hydrogen reduction, Materials Research Bulletin 41(4) (2006) 879-892.
[37] K. H. Park, D. Mishra, C. W. Nam, K. K. Sahu, A. Agrawal, Selective reduction of Cu from aqueous solutions through hydrothermal route for production of Cu powders, Hydrometallurgy 157(2015) 280-284.
[39] N. L. Pacioni, V. Filippenko, N. Presseau, J. C. Scaiano, Oxidation of copper nanoparticles in water: mechanistic insights revealed by oxygen uptake and spectroscopic methods, Dalton Transactions 16(1) (2013) 5832-5838.

What is claimed is:

1. A method for selective recovery of dissolved ions from an aqueous medium, comprising:
(a) providing a first chamber comprising the aqueous medium and a plurality of conductive porous particles, wherein said plurality of conductive porous particles is in conductive contact with a catalyst, said catalyst being capable of catalyzing an oxidation reaction upon exposure to a reductant in the aqueous medium and/or a reduction reaction upon exposure to an oxidant in the aqueous medium;
(b) contacting the aqueous medium comprising the dissolved ions with said plurality of conductive porous particles;
(c) if the dissolved ions are cations, introducing a reductant into the aqueous medium in said first chamber, thereby oxidizing said reductant, to thereby adsorb the dissolved ions to afford adsorbed ions on said plurality of conductive porous particles; or
if the dissolved ions are anions, introducing an oxidant into the aqueous medium in said first chamber, thereby reducing said oxidant, to thereby adsorb the dissolved ions to afford adsorbed ions on said plurality of conductive porous particles;
(d) subsequent to (c), contacting said plurality of conductive porous particles with a regeneration solution, optionally in a second chamber;
(e) if the dissolved ions comprises at least one cation, introducing an oxidant into said regeneration solution, thereby reducing said oxidant, and thereby releasing said adsorbed ions into said regeneration solution as dissolved cations; or
if the dissolved ions comprises at least one anion, introducing a reductant into said regeneration solution, thereby oxidizing said reductant, and thereby releasing said adsorbed ions into said regeneration solution as dissolved anions;
and
(f) recovering said regeneration solution enriched in the dissolved ions,
wherein said dissolved ions are recovered through repeated cycles comprising (c) and (e).

2. The method of claim 1, wherein each of said conductive porous particles comprises a conductive porous substance in a form of a granule, a powder, a fiber, a felt, a paper or a fleece, said substance is selected from the group comprising activated carbon, a carbon aerogel, a carbon nanotube, or a combination thereof.

3. The method of claim 2, wherein said conductive porous particles comprise a pseudocapacitive material, said pseudocapacitive material is selected from the group consisting of a transition metal oxide and a transition metal sulfide.

4. The method of claim 3, wherein said pseudocapacitive material is selected from the group consisting of ruthenium oxide (RuO2), iridium oxide (IrO2), iron oxide (Fe3O4), manganese oxide (MnO2), titanium sulfide (TiS2), Co3O4, cobalt sulfides (CoSx) nickel sulfides (NiSx), metal nitrides (TiN, VN, MON), layered double hydroxides (LDHs) (e.g., CoAl-LDH on Indium-Tin Oxide substrate, graphene nanosheet/NiAl-LDH), polypyrrole, polyaniline, poly (styrene sulfonate), poly(3,4-ethylenedioxythiophene), polythiophene polymethyl methacrylate, phospahe-based nanomaterials (e.g., LiFePO4, Na3V2(PO4)3) and any combination thereof.

5. The method of claim 2, wherein said catalyst is loaded on said conductive porous substance.

6. The method of claim 2, wherein said catalyst is suspended in the medium, and optionally separated from said conductive porous particles by a conductive membrane.

7. The method of claim 1, wherein said catalyst is in the form selected from the group comprising a mixture or/and alloy of nano- or/and micro-scale particles of a mono-functional or/and a bi-functional catalyst.

8. The method of claim 1, wherein said catalyst is selected from the group comprising a transition metal, an enzyme, and a microorganism cell.

9. The method of claim 1, wherein said reductant selected from the group consisting of a reductant gas, a carbohydrate, a hydrocarbon, an alcohol, a carboxylic acid, a borohydride, a particulate solid organic substance in wastewater, and a combination thereof.

10. The method of claim 9, wherein said reductant gas is selected from the group consisting of hydrogen, SO2, H2S, CO, NH3, CH4, and any combination thereof.

11. The method of claim 1, wherein said oxidant is selected from the group consisting of an oxidant gas, an active chlorine species, a chloramine, a permanganate, a dichromate, and any combination thereof.

12. The method of claim 11, wherein said oxidant gas is selected from the group consisting of oxygen, O3, H2O2, F2, Cl2, NO, NO2, and any combination thereof.

13. The method of claim 1, wherein anion is selected from the group consisting of nitrate, perchlorate, chlorate, bromate and nitrite, and said reductant is capable of further reducing said anions.

14. The method of claim 1, wherein the dissolved ions are dissolved metal ions, and said adsorbed ions further undergo reduction to elemental metal and said releasing comprises oxidizing said elemental metal to said dissolved cations.

15. The method of claim 14, wherein said dissolved metal ions are selected from the group comprising Cu²⁺ and Ni²⁺.

16. The method of claim 14, configured to promote selective reduction of targeted metal ions relative to non-targeted metal ions.

17. The method of claim 16, configured for sequential reduction steps at different durations to selectively accumulate different metals in a predetermined order, wherein said selective reduction is effected by introducing said reductant for a controlled duration of time sufficient to reduce said targeted metal ions relative to said non-targeted metal ions.

18. The method of claim 17, further comprising separately oxidizing accumulated metals in sequential regeneration steps to obtain distinct regeneration solutions enriched in different metals.

19. The method of claim 14, wherein reduction is controlled by adjusting a concentration of said reductant to selectively reduce metal ions having higher reduction potentials prior to metal ions having lower reduction potentials.

20. The method of claim 14, wherein oxidation during said regeneration is controlled to preferentially oxidize an accumulated metal having a relative lower oxidation resistance prior to accumulated metal having a corresponding higher reduction potentials.
